(19) United States
(12) Patent Application Publication
(10) Pub. No.: US 2020/0392379 A1
(43) Pub. Date: Dec. 17, 2020

(54) TRANSFER FILM, METHOD FOR MANUFACTURING LAMINATE, LAMINATE, CAPACITIVE INPUT DEVICE, AND IMAGE DISPLAY DEVICE

(71) Applicant: FUJIFILM Corporation, Tokyo (JP)

(72) Inventors: Hideyuki NAKAMURA, Fujinomiya-shi (JP); Hidenori GOTO, Fujinomiya-shi (JP)

(73) Assignee: FUJIFILM Corporation, Tokyo (JP)

(21) Appl. No.: 17/008,932

(22) Filed: Sep. 1, 2020

Related U.S. Application Data
(63) Continuation of application No. PCT/JP2019/009011, filed on Mar. 7, 2019.

(30) Foreign Application Priority Data
Mar. 30, 2018 (JP) 2018-068890

(51) Int. Cl. C09J 7/29; C09J 7/38; G06F 3/044

(52) U.S. Cl. CPC C09J 7/29; G06F 3/0446; C09J 7/385

(57) ABSTRACT

A transfer film has a temporary support, a pressure sensitive adhesive layer, and a metal oxide particle-containing layer containing metal oxide particles in this order. The variation of a content of the metal oxide particles in the metal oxide particle-containing layer is equal to or smaller than 10% in a film thickness direction.

### CROSS-REFERENCE TO RELATED APPLICATIONS

This application is a Continuation of PCT International Application No. PCT/JP2019/009011 filed on Mar. 7, 2019, which claims priority under 35 U.S.C § 119(a) to Japanese Patent Application No. 2018-068890 filed on Mar. 30, 2018. Each of the above application(s) is hereby expressly incorporated by reference, in its entirety, into the present application.

### BACKGROUND OF THE INVENTION

### 1. Field of the Invention

The present disclosure relates to a transfer film, a method for manufacturing a laminate, a laminate, a capacitive input device, and an image display device.

### 2. Description of the Related Art

In a display device comprising a capacitive touch panel or the like, a patterned indium tin oxide (ITO) transparent electrode (transparent electrode pattern) or the like is used.

It is known that a refractive index-adjusting layer is formed on the transparent electrode pattern in the aforementioned display device or the like such that the visibility of the transparent electrode pattern is reduced.

Furthermore, it is known that the refractive index-adjusting layer is formed using a transfer film such that the process is simplified.

For example, JP2014-108541A describes a transfer film having a temporary support, a first curable transparent resin layer, and a second curable transparent resin layer that is disposed adjacent to the first curable transparent resin layer in this order, in which a refractive index of the second curable transparent resin layer is higher than a refractive index of the first curable transparent resin layer and is equal to or higher than 1.60.

JP2017-024262A describes a transparent conductive film laminate including a support, a transparent pressure sensitive adhesive layer on the support, a transparent film base material on the transparent pressure sensitive adhesive layer, and a transparent conductive layer on the transparent film base material, in which the transparent pressure sensitive adhesive layer includes a base pressure sensitive adhesive section that extends in a thickness direction from one main surface and is basically formed of a transparent pressure sensitive adhesive base material and a transparent pressure sensitive refractive index-adjusting section that is formed along the thickness direction from the other main surface of the pressure sensitive adhesive layer, the base pressure sensitive adhesive section contacts the transparent film base material, the refractive index-adjusting section contacts the support and has a refractive index higher than a refractive index of the pressure sensitive adhesive base material.

### SUMMARY OF THE INVENTION

As described in JP2014-108541A, it is known that a refractive index-adjusting layer is formed on a transparent electrode pattern such that the visibility of the transparent electrode pattern is reduced.

In JP2014-108541A, in order to protect the refractive index-adjusting layer, a first curable transparent resin layer (also referred to as “overcoat layer”) is disposed on the refractive index-adjusting layer (a second curable transparent resin layer).

For example, in manufacturing a touch panel having an image display device such as a liquid crystal display device or an organic EL display device, a polarizing film, a retardation film, a cover glass, and various other optical members are bonded onto the aforementioned refractive index-adjusting layer.

Therefore, for example, in a case where the refractive index-adjusting layer and the overcoat layer are formed using the transfer film according to JP2014-108541A, for instance, in a state where the refractive index-adjusting layer is being protected with the overcoat layer, a pressure sensitive adhesive layer is additionally formed on the overcoat layer and bonded to other optical members.

Furthermore, JP2017-024262A describes a transfer film on which at least a pressure sensitive adhesive layer and a refractive index-adjusting layer are laminated. In a case where this transfer film is used, it is possible to form a member having a pressure sensitive adhesive layer on a refractive index-adjusting layer without forming the overcoat layer described above.

However, as a result of intensive studies, the inventors of the present invention have found that because the transfer film according to JP2017-024262A has, as a refractive index-adjusting layer, a transparent pressure sensitive adhesive refractive index-adjusting section that is formed along a thickness direction from the other main surface of the pressure sensitive adhesive layer, the refractive index varies (changes) along the film thickness direction, and thus the visibility of the transparent electrode pattern is insufficiently reduced in some cases.

An object of an embodiment according to the present disclosure is to provide a transfer film that makes it possible to form a metal oxide particle-containing layer and a pressure sensitive adhesive layer in this order and to obtain a laminate which excellently reduces the visibility of a transparent electrode pattern, and a method for manufacturing a laminate using the transfer film.

An object of another embodiment according to the present disclosure is to provide a laminate which has a metal oxide particle-containing layer and a pressure sensitive adhesive layer adjacent to the metal oxide particle-containing layer in this order and in which the visibility of a transparent electrode pattern is excellently reduced, a capacitive input device including the laminate, and an image display device comprising the capacitive input device.

Means for achieving the above objects include the following aspects.

<1> A transfer film including, in the following order, a temporary support, a pressure sensitive adhesive layer, and a metal oxide particle-containing layer containing metal oxide particles, in which a variation of a content of the metal oxide particles in the metal oxide particle-containing layer is equal to or smaller than 10% in a film thickness direction.

<2> The transfer film described in <1>, in which the metal oxide particle-containing layer contains a compound having at least one kind of group selected from the group consisting of a carboxy group and a phosphoric acid group.

<3> The transfer film described in <2>, in which the metal oxide particle-containing layer contains at least one kind of compound selected from the group consisting of a compound that has a carboxy group, does not have an ethylenically unsaturated group, and has a molecular weight less than 2,000 and a compound that has a phosphoric acid group and a molecular weight less than 2,000.

<4> The transfer film described in <3>, in which a total content of the compound that has a carboxy group, does not have an ethylenically unsaturated group, and has a molecular weight less than 2,000 and the compound that has a phosphoric acid group and a molecular weight less than 2,000 is 0.1% by mass to 20% by mass with respect to a total mass of the metal oxide particle-containing layer.

<5> The transfer film described in any one of <2> to <4>, further containing a resin that has at least one of a carboxy group or a phosphoric acid group and has a molecular weight equal to or higher than 2,000 and equal to or lower than 10,000, a glass transition temperature equal to or lower than 23° C., and an acid value equal to or higher than 80 mgKOH/g.

<6> The transfer film described in any one of <1> to <5>, in which the pressure sensitive adhesive layer has a tan δ equal to or higher than 1.5 at 23° C., an elongation at break equal to or higher than 600% at 23° C., and a viscosity equal to or lower than 1.0×10⁶ Pa·s at 23° C.

<7> The transfer film described in any one of <1> to <6>, in which a water vapor transmission rate is equal to or lower than 1,100 g/(m²·day) at 60° C.

<8> The transfer film described in any one of <1> to <7>, in which a thickness of the pressure sensitive adhesive layer is 5 μm to 200 μm.

<9> The transfer film described in any one of <1> to <8>, in which a thickness of the metal oxide particle-containing layer is 30 nm to 1,000 nm.

<10> A method for manufacturing a laminate, including, on a transparent electrode pattern, laminating the metal oxide particle-containing layer and the pressure sensitive adhesive layer in the transfer film described in any one of <1> to <9> in this order.

<11> A laminate having, in the following order, a transparent electrode pattern, a metal oxide particle-containing layer that is disposed adjacent to the transparent electrode pattern and contains metal oxide particles, and a pressure sensitive adhesive layer that is disposed adjacent to the metal oxide particle-containing layer, in which a variation of a content of the metal oxide particles in the metal oxide particle-containing layer is equal to or smaller than 10% in a film thickness direction.

<12> The laminate described in <11>, in which the metal oxide particle-containing layer contains a compound having at least one kind of group selected from the group consisting of a carboxy group and a phosphoric acid group.

<13> The laminate described in <12>, in which the metal oxide particle-containing layer contains at least one kind of compound selected from the group consisting of a compound that has a carboxy group, does not have an ethylenically unsaturated group, and has a molecular weight less than 2,000 and a compound that has a phosphoric acid group and a molecular weight less than 2,000.

<14> The laminate described in <13>, in which a total content of the compound that has a carboxy group, does not have an ethylenically unsaturated group, and has a molecular weight less than 2,000 and the compound that has a phosphoric acid group and a molecular weight less than 2,000 is 0.1% by mass to 20% by mass with respect to a total mass of the metal oxide particle-containing layer.

<15> The laminate described in any one of <11> to <14>, in which the pressure sensitive adhesive layer has a tan δ equal to or higher than 1.5 at 23° C., an elongation at break equal to or higher than 600% at 23° C., and a viscosity equal to or lower than 1.0×10⁶ Pa·s at 23° C.

<16> The laminate described in any one of <11> to <15>, in which the pressure sensitive adhesive layer and the metal oxide particle-containing layer have, as one layer, a water vapor transmission rate equal to or lower than 1,100 g/(m²·day) at 60° C.

<17> The laminate described in any one of <11> to <16>, in which a thickness of the pressure sensitive adhesive layer is 5 μm to 200 μm.

<18> The laminate described in any one of <11> to <17>, in which a thickness of the metal oxide particle-containing layer is 30 nm to 1,000 nm.

<19> A capacitive input device including the laminate described in any one of <11> to <18>.

<20> An image display device comprising the capacitive input device described in <19>.

According to an embodiment of the present disclosure, it is possible to form a metal oxide particle-containing layer and a pressure sensitive adhesive layer in this order, to provide a transfer film making it possible to obtain a laminate in which the visibility of a transparent electrode pattern is excellently reduced, and to provide a method for manufacturing a laminate using the transfer film.

According to another embodiment of the present disclosure, it is possible to provide a laminate which has a metal oxide particle-containing layer and a pressure sensitive adhesive layer adjacent to the metal oxide particle-containing layer in this order and in which the visibility of a transparent electrode pattern is excellently reduced, a capacitive input device including the laminate, and an image display device comprising the capacitive input device.

### BRIEF DESCRIPTION OF THE DRAWINGS

FIG. 1 is a schematic cross-sectional view showing an example of a transfer film according to an embodiment of the present disclosure.

FIG. 2 is a schematic cross-sectional view showing an example of the constitution of a capacitive input device according to an embodiment of the present disclosure.

FIG. 3 is a view illustrating an example of the relationship between a transparent electrode pattern and a non-patterned region according to an embodiment of the present disclosure.

FIG. 4 is a view illustrating an example of a tapered shape of the end of a transparent electrode pattern according to an embodiment of the present disclosure.

FIG. 5 is a view illustrating an example of the relationship between a transparent electrode pattern and a non-patterned region according to an embodiment of the present disclosure.

FIG. 6 is a schematic cross-sectional view showing an example of a laminate according to the present disclosure.

FIG. 7 is a view for illustrating a step conformability evaluation method in examples of the present disclosure.

### DESCRIPTION OF THE PREFERRED EMBODIMENTS

Hereinafter, an embodiment of the present invention will be described.

In the present disclosure, in a case where there is no description regarding whether a group (atomic group) is substituent or unsubstituted, the group includes both the group having no substituent and group having a substituent. For example, “alkyl group” includes not only an alkyl group having no substituent (unsubstituted alkyl group) but also an alkyl group having a substituent (substituted alkyl group).

In the present disclosure, a range of numerical values described using “to” means a range including the numerical values listed before and after “to” as the lower limit and the upper limit.

Regarding the ranges of numerical values described stepwise in the present disclosure, the upper limit or lower limit of a range of numerical values may be replaced with the upper limit or lower limit of another range of numerical values described stepwise. Furthermore, the upper limit and lower limit of a range of numerical values described in the present disclosure may be replaced with the values shown in Examples.

In the present disclosure, in a case where a layer such as a metal oxide particle-containing layer contains a plurality of substances as each component, unless otherwise specified, the amount of each component in the layer such as a metal oxide particle-containing layer means the total amount of the plurality of substances in the layer such as a metal oxide particle-containing layer.

In the present disclosure, “(meth)acrylic acid” is a concept that includes both the acrylic acid and methacrylic acid, “(meth)acrylate” is a concept that includes both the acrylate and methacrylate, and “(meth)acryloyl group” is a concept including both the acryloyl group and methacryloyl group.

In addition, the term “step” in the present disclosure includes not only an independent step but also a step that is not clearly differentiated from other steps as long as the intended goal of the step is accomplished.

In the present disclosure, “% by mass” has the same definition as “% by weight”, and “part by mass” has the same definition as “part by weight”.

Furthermore, in the present disclosure, a combination of two or more preferred aspects is a more preferred aspect.

In addition, in the present disclosure, unless otherwise specified, each of the weight-average molecular weight (Mw) and number-average molecular weight (Mn) is a molecular weight that is detected using a gel permeation chromatography (GPC) analysis device using TSKgel GMHxL, TSKgel G4000HxL, and TSKgel G2000HxL (trade names, manufactured by Tosoh Corporation) as columns, tetrahydrofuran (THF) as a solvent, and a differential refractometer, and expressed in terms of polystyrene as a standard substance.

In a case where a molecular weight has a molecular weight distribution, unless otherwise specified, the molecular weight is a weight-average molecular weight.

Unless otherwise specified, a compositional ratio between constitutional units in a polymer is a molar ratio.

In the present disclosure, the amount of total solid contents refers to the total mass of components in a composition except for a volatile component such as a solvent.

In the drawings of the present disclosure, the same constituents are marked with the same references, and the description of details thereof will not be repeated.

In the present disclosure, “light” is a concept that includes active energy rays such as γ rays, β rays, electron beams, ultraviolet rays, visible rays, and infrared rays.

Unless otherwise specified, “exposure” in the present disclosure means not only the exposure performed using a bright line spectrum of a mercury lamp, far ultraviolet rays represented by excimer laser, extreme ultraviolet rays, X-rays, Extreme ultraviolet (EUV) light, and the like, but also the exposure performed using particle beams such as electron beams and ion beams.

In the present disclosure, “transparent” means that a total light transmittance at a wavelength of 400 nm to 800 nm at 23° C. is equal to or higher than 80% (preferably equal to or higher than 90%, and more preferably equal to or higher than 95%). The total light transmittance is measured using an integrating sphere-type light transmittance measuring device (for example, “CM-3600A” (trade name) manufactured by Konica Minolta, Inc.).

(Transfer Film)

The transfer film according to the present disclosure has a temporary support, a pressure sensitive adhesive layer, and a metal oxide particle-containing layer containing metal oxide particles in this order. The variation of a content of the metal oxide particles in the metal oxide particle-containing layer is equal to or smaller than 10% in a film thickness direction.

As a result of intensive studies, the inventors of the present invention have found that in a case where the above constitution is adopted, a metal oxide particle-containing layer and a pressure sensitive adhesive layer can be formed in this order on a transparent electrode pattern, and a laminate is obtained in which the visibility of the transparent electrode pattern is excellently reduced.

The mechanism that brings about the above effect is unclear, but is assumed to be as below.

The metal oxide particle-containing layer in the present disclosure contains metal oxide particles for increasing a refractive index such that the visibility of the transparent electrode pattern is reduced.

Presumably, in a case where the variation of the content of the metal oxide particles is equal to or smaller than 10% in the film thickness direction, the variation of the refractive index in the metal oxide particle-containing layer may be reduced, and the visibility of the transparent electrode pattern may be further reduced.

Furthermore, the transfer film according to the present disclosure makes it possible to form the metal oxide particle-containing layer and the pressure sensitive adhesive layer at once.

In addition, the pressure sensitive adhesive layer can be formed as a layer softer than the overcoat layer described above.

Presumably, as a result, in a case where the transfer film according to the present disclosure is bonded to a member having steps, it may be easy to inhibit the occurrence of bubbles in the portions of the steps.

Moreover, presumably, it may be easy to apply the transfer film, for example, to a touch panel display device having a flexible display portion or the like.

Hereinafter, each of the constituents of the transfer film according to the present disclosure will be described.

<Constitution of Transfer Film>

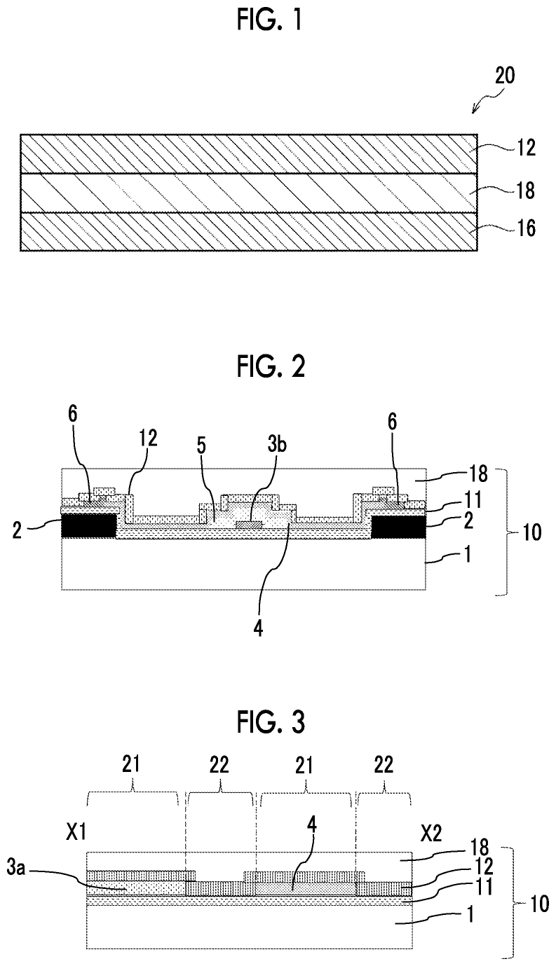

FIG. 1 is a schematic cross-sectional view of a transfer film 20 according to the present disclosure.

The transfer film 20 has a pressure sensitive adhesive layer 18 and a metal oxide particle-containing layer 12 in this order on a temporary support 16.

It is preferable that the temporary support 16 and the pressure sensitive adhesive layer 18 are adjacent to each other. Here, the transfer film may have a layer that is peeled together with the temporary support, such that the pressure sensitive adhesive layer becomes the outermost layer in a case where the temporary support 16 is peeled off.

There may be an interlayer or the like between the pressure sensitive adhesive layer 18 and the metal oxide particle-containing layer 12. However, from the viewpoint of the reduction of visibility of the transparent electrode pattern and the step conformability, it is preferable that the pressure sensitive adhesive layer 18 and the metal oxide particle-containing layer 12 are adjacent to each other.

It is preferable that the metal oxide particle-containing layer 12 has a protective film (not shown in the drawing) that is peeled during transfer.

From the viewpoint of reducing the visibility of the transparent electrode pattern, it is preferable that the metal oxide particle-containing layer 12 and the transparent electrode pattern are adjacent to each other in the laminate. In this respect, the metal oxide particle-containing layer 12 is preferably the outermost layer or adjacent to the protective film.

[WVTR]

From the viewpoint of inhibiting the corrosion of the transparent electrode pattern and metal wiring (such as copper wiring), a water vapor transmission rate (WVTR) of the transfer film at 60° C. is preferably equal to or lower than 1,100 g/(m²·day), more preferably 200 g/(m²·day) to 600 g/(m²·day), and even more preferably 200 g/(m²·day) to 400 g/(m²·day). WVTR is measured using AQUATRAN (MODEL-1) manufactured by AMETEK MOCON in an environment of 60° C. and 90% RH.

WVTR of the transfer film at 60° C. is measured in a state where the temporary support has been peeled from the transfer film. Furthermore, in a case where the transfer film has a cover film which will be described later, WVTR is measured in a state where the cover film has also been peeled. In reality, WVTR of a laminate transferred to a membrane filter is measured (because WVTR of the membrane filter is extremely higher than WVTR of the transfer film, what is substantially measured is WVTR of the transfer film).

In the present disclosure, WVTR of the transfer film at 60° C. can be made fall into the above range, for example, by designing the composition, thickness, and the like of the pressure sensitive adhesive layer that will be described later.

Hereinafter, details of each layer will be described.

<Metal Oxide Particle-Containing Layer>

The transfer film according to the present disclosure has a metal oxide particle-containing layer.

It is preferable that the metal oxide particle-containing layer in the present disclosure is transparent.

In the present disclosure, a refractive index of the metal oxide particle-containing layer at 23° C. and a wavelength of 400 nm to 750 nm is preferably 1.55 to 2.00, more preferably 1.60 to 1.90, even more preferably 1.61 to 1.89, and most preferably 1.62 to 1.75.

In the present disclosure, a case where a refractive index at a wavelength of 400 nm to 750 nm is, for example, equal to or higher than 1.50 means that the average refractive index for light having a wavelength in the above range is equal to or higher than 1.50, and it is not necessary for the refractive index to be equal to or higher than 1.50 for all light having the wavelength in the above range. Furthermore, the average refractive index is a value obtained by dividing the sum of refractive indices measured at an interval of 1 nm for lights having the wavelengths in the above range by the number of measurement spots.

In the present disclosure, a refractive index of the metal oxide particle-containing layer at a wavelength of 550 nm is preferably 1.55 to 2.00, more preferably 1.60 to 1.90, even more preferably 1.61 to 1.89, and most preferably 1.62 to 1.75.

In the present disclosure, a refractive index of the metal oxide particle-containing layer at a wavelength of 633 nm is preferably 1.55 to 2.00, more preferably 1.60 to 1.90, even more preferably 1.61 to 1.89, and most preferably 1.62 to 1.75.

In the present disclosure, a refractive index of the metal oxide particle-containing layer is preferably higher than a refractive index of the pressure sensitive adhesive layer that will be described later.

In the present disclosure, unless otherwise specified, a refractive index is a value measured using an ellipsometer at 23° C. and a wavelength of 550 nm.

[Metal Oxide Particles]

The metal oxide particle-containing layer in the present disclosure contains metal oxide particles. Because the metal oxide particle-containing layer contains metal oxide particles, the refractive index and the light-transmitting properties of the obtained metal oxide particle-containing layer are excellent.

A refractive index of the metal oxide particles at 23° C. and a wavelength of 400 nm to 750 nm is preferably equal to or higher than 1.50, more preferably equal to or higher than 1.70, and even more preferably equal to or higher than 1.90.

The upper limit of the refractive index of the metal oxide particles is not particularly limited, and may be equal to or lower than 3.0 for example.

Metals of the metal oxide particles in the present disclosure include semimetals such as B, Si, Ge, As, Sb, and Te.

As metal oxide particles that transmit light and have a high refractive index, oxide particles containing atoms of Be, Mg, Ca, Sr, Ba, Sc, Y, La, Ce, Gd, Tb, Dy, Yb, Lu, Ti, Zr, Hf, Nb, Mo, W, Zn, B, Al, Si, Ge, Sn, Pb, Sb, Bi, Te, and the like are preferable, titanium oxide, titanium composite oxide, zinc oxide, zirconium oxide, tin oxide, zirconium/tin oxide, indium/tin oxide, and antimony/tin oxide are more preferable, titanium oxide, titanium composite oxide, tin oxide, and zirconium oxide are even more preferable, titanium oxide or zirconium oxide is particularly preferable, and zirconium oxide is most preferable. As the titanium oxide, titanium dioxide is preferable. As the titanium dioxide, a rutile type having a particularly high refractive index is preferable.

The surface of these metal oxide particles can be treated with an organic material such that the particles obtain dispersion stability.

—Particle Size—

From the viewpoint of transparency of the metal oxide particle-containing layer, an average primary particle size of the metal oxide particles is preferably 1 nm to 200 nm, and particularly preferably 3 nm to 80 nm. The average primary particle size of the metal oxide particles refers to the arithmetic mean of particle sizes measured for 200 random particles by using an electron microscope. In a case where the particles are not in the form of spheres, the longest diameter of each particle is taken as a particle size.

One kind of metal oxide particles described above may be used singly, or two or more kinds of the metal oxide particles described above may be used in combination.

The content of the metal oxide particles in the metal oxide particle-containing layer may be appropriately determined in consideration of the refractive index, light-transmitting properties, and the like required for the optical member to be obtained. The content of the metal oxide particles with respect to the total mass of the metal oxide particle-containing layer is preferably 5% by mass to 95% by mass, more preferably 50% by mass to 95% by mass, and most preferably 65% by mass to 90% by mass.

Examples of titanium oxide particles include TS-020 (an aqueous dispersion, content of non-volatile components: 25.6% by mass) manufactured by TAYCA, TITANIA SOL R (a methanol dispersion, content of non-volatile components: 32.1% by mass) manufactured by NISSAN CHEMICAL INDUSTRIES, LTD., and the like.

Examples of zirconium oxide particles include NanoUse OZ-S30M (a methanol dispersion, content of non-volatile components: 30.5% by mass) manufactured by NISSAN CHEMICAL INDUSTRIES, LTD., SZR-CW (an aqueous dispersion, content of non-volatile components: 30% by mass) and SZR-M (a methanol dispersion, content of non-volatile components: 30% by mass) manufactured by SAKAI CHEMICAL INDUSTRY CO., LTD.), and the like.

—Variation in Film Thickness Direction—

In the present disclosure, a variation of the content of metal oxide particles in the metal oxide particle-containing layer in a film thickness direction is equal to or smaller than 10%, preferably equal to or smaller than 8%, and more preferably equal to or smaller than 5%.

For example, in a case where the metal oxide particles include zirconium oxide particles, in order to determine the variation described above, by using an XPS device “PHI-5600” (manufactured by ULVAC-PHI, INCORPORATED), argon sputtering (4 kV) is performed such that the film is cut off from the film surface along the film thickness direction, and a ratio of a content of Zr atoms to a content of carbon atoms within the film surface is measured by X-ray photoelectron spectroscopy. By the X-ray photoelectron spectroscopy, a ratio of a content of Zr atoms to a content of carbon atoms at each of a 10% film thickness spot, a 50% film thickness spot, and a 90% film thickness spot is measured along the entire thickness direction of the film (film thickness direction). Among the absolute values of differences between the average of the values measured at these three spots and each of the values measured at these three spots, the largest value is adopted as the variation. The 10% (50% or 90%) film thickness refers to a position within a surface formed as a result of cutting off the metal oxide particle-containing layer from the initial surface thereof until the film thickness of the metal oxide particle-containing layer is reduced by 10% (50% or 90%).

Even though other particles are used as metal oxide particles, the variation can be calculated by the same method as that adopted in a case where the aforementioned zirconium oxide particles are used.

In a case where the metal oxide particle-containing layer contains a plurality of kinds of metal oxide particles, the total amount of the metals is adopted as the content of the metal oxide particles.

[Resin]

It is preferable that the metal oxide particle-containing layer contains a resin. As a binder polymer, a known polymer can be used. The resin is preferably an acrylic resin having a carboxylic acid on a side chain. The weight-average molecular weight of the resin is preferably 5,000 to 50,000. For example, it is possible to use the resin (A) described in paragraph “0025” of JP2011-095716A and paragraphs “0033” to “0052” of JP2010-237589A.

The resin is not particularly limited, but is preferably a (meth)acrylic resin.

The (meth)acrylic resin refers to a resin having at least one of a constitutional unit derived from a (meth)acrylic acid or a constitutional unit derived from a(meth) acrylic acid ester.

The total proportion of the constitutional unit derived from a (meth)acrylic acid and the constitutional unit derived from a (meth)acrylic acid ester in the (meth)acrylic resin is preferably equal to or higher than 30 mol %, and more preferably equal to or higher than 50 mol %. The upper limit thereof is not particularly limited and may be equal to or lower than 100 mol %.

Furthermore, it is preferable that the resin has an ethylenically unsaturated group.

In a case where the resin has an ethylenically unsaturated group, the metal oxide particle-containing layer exhibits excellent adhesiveness to the pressure sensitive adhesive layer that will be described later.

Examples of the ethylenically unsaturated group include a vinyl group, a (meth)acryloyl group, an allyl group, and the like.

These ethylenically unsaturated groups may be introduced into the resin by using monomers having the ethylenically unsaturated groups during the manufacturing of the resin, or may be introduced into the resin by a polymer reaction or the like.

As the resin, in addition to the aforementioned (meth)acrylic resin, any film-forming resin can be appropriately selected and used according to the purpose. In order to improve surface hardness and heat resistance, a known photosensitive siloxane resin material or the like may also be used.

One kind of resin described above may be used singly, or two or more kinds of resins described above may be used in combination.

The content of the resin with respect to the total mass of the metal oxide particle-containing layer is preferably 0% by mass to 40% by mass, and more preferably 10% by mass to 30% by mass.

[Compound Having at Least One Kind of Group Selected from the Group Consisting of Carboxy Group and Phosphoric Acid Group]

It is preferable that the metal oxide particle-containing layer contains a compound having at least one kind of group selected from the group consisting of a carboxy group and a phosphoric acid group (hereinafter, the compound will be also referred to as “specific compound”).

In a case where the metal oxide particle-containing layer contains the specific compound, the occurrence of cracks in the formed metal oxide particle-containing layer is inhibited, and the visibility of the transparent electrode pattern is more easily reduced.

As the specific compound, at least one kind of compound (hereinafter, also referred to as “specific compound A”) is preferable which is selected from the group consisting of a compound that has a carboxy group, does not have an ethylenically unsaturated group, and has a molecular weight (a weight-average molecular weight in a case where the molecular weight has a molecular weight distribution) less than 2,000 and a compound that has a phosphoric acid group and a molecular weight less than 2,000.

—Compound Having Carboxy Group, Having No Ethylenically Unsaturated Group, and Having Molecular Weight Less than 2,000—

The molecular weight of the compound that has a carboxy group, does not have an ethylenically unsaturated group, and has a molecular weight less than 2,000 is preferably equal to or higher than 120 and equal to or lower than 1,000.

The molecular weight can be measured by known mass spectrometry.

Furthermore, the compound that has a carboxy group, does not have an ethylenically unsaturated group, and has a molecular weight less than 2,000 may be a compound having only one carboxy group or a compound having a plurality of carboxy groups, but is preferably a compound having a plurality of carboxy groups.

pKa of the carboxy group in the compound that has a carboxy group, does not have an ethylenically unsaturated group, and has a molecular weight less than 2,000 is preferably 1.0 to 6.0, and more preferably 1.0 to 4.0. In a case where the compound that has a carboxy group and a molecular weight less than 2,000 has a plurality of pKa values, the aforementioned pKa is the minimum pKa among the plurality of pKa values.

Examples of the compound that has a carboxy group, does not have an ethylenically unsaturated group, and has a molecular weight less than 2,000 include phthalic acid, trimellitic acid, maleic acid, benzoic acid, citric acid, and the like.

—Compound Having Phosphoric Acid Group and Molecular Weight Less than 2,000—

The molecular weight of the compound that has a phosphoric acid group and a molecular weight less than 2,000 is preferably equal to or higher than 120 and equal to or lower than 1,000.

The molecular weight can be measured by known mass spectrometry.

Furthermore, the compound that has a phosphoric acid group and a molecular weight less than 2,000 preferably further has an ethylenically unsaturated group.

The ethylenically unsaturated group is not particularly limited, and examples thereof include a (meth)acryloyl group, a vinyl group, an allyl group, and the like.

The compound that has a phosphoric acid group and a molecular weight less than 2,000 may be a compound having only one phosphoric acid group or a compound having a plurality of phosphoric acid groups.

Examples of the compound that has a phosphoric acid group and a molecular weight less than 2,000 include LIGHT ESTER P-2M (manufactured by KYOEISHA CHEMICAL Co., LTD), and the like.

—Specific Compound B—

As the specific compound, a resin (hereinafter, also referred to as “specific compound B”) can also be preferably used which has at least one of a carboxy group or a phosphoric acid group, a molecular weight equal to or higher than 2,000 and equal to or lower than 10,000, a glass transition temperature (Tg) equal to or lower than 23° C., and an acid value equal to or higher than 80 mgKOH/g.

In the present disclosure, a glass transition temperature of a polymer such as a resin can be measured by differential scanning calorimetry (DSC).

Specifically, the glass transition temperature is measured according to the method described in JIS K 7121 (1987) or JIS K 6240 (2011). In the present specification, an extrapolated glass transition onset temperature (hereinafter, referred to as Tig in some cases) is used as the glass transition temperature.

The method of measuring the glass transition temperature will be more specifically described.

In order to determine the glass transition temperature, the device is kept at a temperature approximately 50° C. lower than the expected Tg until the device stabilizes and then heated at a heating rate of 20° C./min to a temperature approximately 30° C. higher than the temperature at which the glass transition ends, and a DTA curve or a DSC curve is plotted.

The extrapolated glass transition onset temperature (Tig), that is, the glass transition temperature Tg in the present specification is determined as a temperature at an intersection point between a straight line that is obtained by extending the baseline of a low temperature side in the DTA curve or the DSC curve to a high temperature side and a tangent line that is drawn at a point where the slope of the curve of a portion in which the glass transition temperature stepwise changes is maximum.

As a method of adjusting Tg to the aforementioned preferred range, for example, based on Tg of a homopolymer of each of the constitutional units of the intended polymer and on the mass ratio between the constitutional units, Tg of the intended specific polymer can be controlled by using FOX equation as a guide.

FOX Equation

Provided that Tg of a homopolymer of a first constitutional unit included in a polymer is Tg1, a mass fraction of the first constitutional unit in a copolymer is W1, Tg of a homopolymer of a second constitutional unit is Tg2, and a mass fraction of a copolymer of the second constitutional unit is W2, Tg0 (K) of a copolymer including the first constitutional unit and the second constitutional unit can be estimated according to the following equation.

1/Tg0=(W1/Tg1)+(W2/Tg2) FOX equation:

In a case where the type and mass fraction of each of constitutional units included in a copolymer are adjusted using the FOX equation described above, it is possible to obtain a copolymer having desired Tg.

Furthermore, in a case where the weight-average molecular weight of a polymer is adjusted, It is also possible to adjust Tg of the polymer.

The acid value of a polymer such as a resin in the present disclosure represents the mass of potassium hydroxide required to neutralize acidic components per 1 g of the polymer. Specifically, a measurement sample is dissolved in a tetrahydrofuran/water=9/1 mixed solvent, and by using a potentiometric titrator (trade name: AT-510, manufactured by KYOTO ELECTRONICS MANUFACTURING CO., LTD.), the obtained solution is neutralized by being titrated with a 0.1 M aqueous sodium hydroxide solution at 23° C. The acid value is calculated by the following equation by using an inflection point of a titration pH curve as the end point of titration.

A=56.11×Vs×0.1×f/w

A: Acid value (mgKOH/g)

Vs: amount of 0.1 mol/l aqueous sodium hydroxide solution used for titration (mL)

f: titer of 0.1 mol/l aqueous sodium hydroxide solution

w: mass of measurement sample (g) (expressed in terms of solid contents)

<<Resin Having Carboxy Group, Weight-Average Molecular Weight Equal to or Higher than 2,000 and Equal to or Lower than 10,000, and Tg Equal to or Lower than 23° C.>>

From the viewpoint of inhibiting the corrosion of metal wiring, as the specific compound, it is preferable to use a resin that has a carboxy group, a molecular weight equal to or higher than 2,000 and equal to or lower than 10,000, a glass transition temperature (Tg) equal to or lower than 23° C., and an acid value equal to or higher than 80 mgKOH/g.

The molecular weight is preferably 2,000 to 8,000, and more preferably 2,500 to 5,000.

The Tg is preferably −40° C. to 30° C., and more preferably −20° C. to 25° C. The acid value is preferably 80 mgKOH/g to 300 mgKOH/g, and more preferably 80 mgKOH/g to 200 mgKOH/g from the viewpoint of solubility.

The resin is preferably an acrylic resin.

As the resin, for example, ACTFLOW CB-3060, CB-3098, and CB-CBB-3098 manufactured by Soken Chemical & Engineering Co., Ltd., and the like are preferable.

<<Resin Having Phosphoric Acid Group, Weight-Average Molecular Weight Equal to or Higher than 2,000 and Equal to or Lower than 10,000, and Tg Equal to or Lower than 23° C.>>

From the viewpoint of inhibiting the corrosion of metal wiring, as the specific compound, it is preferable to use a resin that has a phosphoric acid group, a molecular weight equal to or higher than 2,000 and equal to or lower than 10,000, Tg equal to or lower than 23° C., and an acid value equal to or higher than 80 mgKOH/g.

As the resin that has a phosphoric acid group, it is preferable to use a resin that has a phosphoric acid group on a side chain.

The resin that has a phosphoric acid group may have an ethylenically unsaturated group. However, it is preferable that the resin does not have an ethylenically unsaturated group.

The resin that has a phosphoric acid group is preferably a resin that has a constitutional unit having a phosphoric acid group.

The resin that has a phosphoric acid group is obtained, for example, using a monomer having a phosphoric acid group during the manufacturing of the resin.

—Content—

The metal oxide particle-containing layer according to the present disclosure may contain only one kind of specific compound or contain two or more kinds of specific compounds in combination.

The content of the specific compound with respect to the total mass of the metal oxide particle-containing layer is preferably 0.1% by mass to 50% by mass, and more preferably 1.0% by mass to 40% by mass.

Furthermore, the total content of the specific compound A with respect to the total mass of the metal oxide particle-containing layer is preferably 0.1% by mass to 20% by mass, and more preferable 1.0% by mass to 10.0% by mass.

[Other Polymerizable Compounds]

The metal oxide particle-containing layer in the present disclosure may further contain other polymerizable compounds in addition to the resin and specific compound described above.

Examples of those other polymerizable compounds include compounds that have at least one addition-polymerizable ethylenically unsaturated group in a molecule and have a boiling point equal to or higher than 100° C. under normal pressure. Examples of such compounds include monofunctional acrylates or monofunctional methacrylates such as polyethylene glycol mono(meth)acrylate, polypropylene glycol mono(meth)acrylate, and phenoxyethyl(meth)acrylate; and polyfunctional acrylates or polyfunctional methacrylates such as polyethylene glycol di(meth)acrylate, polypropylene glycol di(meth)acrylate, trimethylolethane triacrylate, trimethylolpropane triacrylate, trimethylolpropane diacrylate, neopentyl glycol di(meth)acrylate, pentaerythritol tetra(meth)acrylate, pentaerythritol tri(meth)acrylate, dipentaerythritol hexa(meth)acrylate, dipentaerythritol penta(meth)acrylate, hexanediol di(meth)acrylate, trimethylolpropane tri(acryloyloxypropyl) ether, tri(acryloyloxyethyl)isocyanurate, tri(acryloyloxyethyl)cyanurate, glycerin tri(meth)acrylate; compounds obtained by adding ethylene oxide or propylene oxide to polyfunctional alcohols such as trimethylolpropane or glycerin and then (meth)acrylating the resulting substances; and compounds obtained by adding a dicarboxylic acid or a carboxylic anhydride to a polyfunctional alcohols such as dipentaerythritol and then (meth)acrylating the resulting substances.

[Polymerization Initiator or Polymerization Initiation System]

The metal oxide particle-containing layer in the present disclosure may further contain a polymerization initiator or a polymerization initiation system. The polymerization initiator or polymerization initiation system is not particularly limited, and examples thereof include the polymerization initiator or polymerization initiation system described in paragraphs “0031” to “0042” of JP2011-095716A.

[Other Additives]

The metal oxide particle-containing layer may further contain other additives. Examples of those other additives include the surfactants described in paragraph “0017” of JP4502784B and in paragraphs “0060” to “0071” of JP2009-237362A, the thermal polymerization inhibitors described in paragraph “0018” of Japanese JP4502784B, other additives described in paragraphs “0058” to “0071” of JP2000-310706A, and the like.

[Metal Oxide Particle-Containing Layer as Positive Material]

The metal oxide particle-containing layer may be a positive type material. In a case where the metal oxide particle-containing layer is a positive material, for example, the materials described in JP2005-221726A and the like are used, but the material of the metal oxide particle-containing layer is not limited thereto.

[Thickness]

The thickness of the metal oxide particle-containing layer is preferably 30 nm to 1,000 nm, more preferably 30 nm to 300 nm, and most preferably 50 nm to 150 nm.

<Pressure Sensitive Adhesive Layer>

The transfer film according to the present disclosure has a pressure sensitive adhesive layer.

The pressure sensitive adhesive layer is not particularly limited as long as it exhibits adhesiveness under pressure. It is preferable that a peel force of the pressure sensitive adhesive layer is equal to or higher than 0.2 N/mm in a case where a glass substrate is attached to the layer. The peel force is measured by performing a 180° peel test at a tensile speed of 300 mm/min in a room temperature environment (23° C.).

[Characteristics of Pressure Sensitive Adhesive Layer]

— Tan δ—From the viewpoint of excellent step conformability, a tan δ of the pressure sensitive adhesive layer at 23° C. is preferably equal to or higher than 1.5, more preferably higher than 1.5, and even more preferably 2.0 to 4.0.

In the present disclosure, tan δ is obtained as a ratio of G″ (loss modulus) to G′ (storage modulus) (G″/G′) in viscometry. The storage modulus G′ and loss modulus G″ are measured according to the method described in JIS K 7244-1:1998.

—Elongation at Break—

In the present disclosure, from the viewpoint of excellent step conformability, an elongation at break of the pressure sensitive adhesive layer at 23° C. is preferably equal to or higher than 600%, and more preferably 600% to 1,000%. The elongation at break is measured by pulling a sample film which is a self-supporting film having a film thickness of 75 μm, a length of 30 mm, and a width of 5 mm by using a tensile tester (manufactured by Tensilon). The elongation at break is measured at an inter-chuck distance of 20 mm, 23° C., and a relative humidity of 50%.

—Viscosity—

In the present disclosure, from the viewpoint of excellent step conformability, a viscosity of the pressure sensitive adhesive layer at 23° C. is preferably equal to or lower than 1.0×10⁶ Pa·s, and more preferably equal to or higher than 1.0×10⁴ Pa·s and equal to or lower than 1.0×10⁶ Pa·s.

The viscosity is measured using a rheometer DHR-2 (with a 20 mmf parallel plate and a Peltier plate (Gap: about 0.5 mm)) manufactured by TA Instruments Japan under the conditions of a measurement start temperature of 20° C., a measurement end temperature of 50° C., a heating rate of 5° C./min, a frequency 1 Hz, and a strain of 0.5%. The sample is dissolved at about 80° C. on the Peltier plate and measured in a constant-Gap (0.5 mm) mode. The Peltier plate is controlled such that the sample becomes 75 μm thick on the plate, and the film thickness is measured in a constant-load (1N) mode.

From the viewpoint of step conformability, the pressure sensitive adhesive layer in the present disclosure preferably has a tan δ equal to or higher than 1.5 at 23° C., an elongation at break equal to or higher than 600% at 23° C., and a viscosity equal to or lower than 1.0×10⁶ Pa·s at 23° C.

The preferred range of each of the tan δ, elongation at break, and viscosity is as described above.

—Peel Force—

In order that peeling easily occurs at the interface between the temporary support and the pressure sensitive adhesive layer, a peel force between the temporary support and the pressure sensitive adhesive layer is preferably equal to or lower than 5.0 N/25 mm (0.2 N/mm).

Furthermore, in order that peeling hardly occurs at the interface between the pressure sensitive adhesive layer and the metal oxide particle-containing layer, a peel force between the pressure sensitive adhesive layer and the metal oxide particle-containing layer is preferably equal to or higher than 5.0 N/25 mm.

The peel force is measured by performing a 180° peel test at a tensile speed of 300 mm/min in a room temperature environment (23° C.).

—Optical Characteristics—

It is preferable that the pressure sensitive adhesive layer in the present disclosure is transparent.

In addition, a refractive index of the pressure sensitive adhesive layer in the present disclosure at 23° C. and a wavelength of 400 nm to 750 nm is preferably 1.40 to 1.60, and more preferably 1.45 to 1.55.

[Composition for Forming Pressure Sensitive Adhesive Layer]

The pressure sensitive adhesive layer in the present disclosure is obtained by curing or drying a composition for forming a pressure sensitive adhesive layer.

For example, the pressure sensitive adhesive layer is obtained by curing a composition for forming a pressure sensitive adhesive layer that contains rubber, a viscosity imparting agent as an optional component, a polymerizable monomer, and a polymerization initiator or by drying a composition for forming a pressure sensitive adhesive layer that contains a polymerizable monomer, a resin, and a solvent.

Hereinafter, the components contained in the composition for forming a pressure sensitive adhesive layer in the present disclosure and the components that can be contained in the composition will be described.

—Rubber—

It is preferable that the composition for forming a pressure sensitive adhesive layer in the present disclosure contains rubber. In a case where the composition for forming a pressure sensitive adhesive layer (pressure sensitive adhesive layer) contains rubber, hydrophobicity of the pressure sensitive adhesive layer is improved, and WVTR described above and a relative dielectric constant of the obtained capacitive input device can be reduced.

It is preferable that the rubber contained in the composition for forming a pressure sensitive adhesive layer in the present disclosure is in a liquid form at room temperature (23° C.). Furthermore, it is preferable that the rubber that is in a liquid form at room temperature is used in combination with additive rubber which will be described later.

The weight-average molecular weight of the rubber that is in a liquid form at room temperature is preferably 1,000 to 100,000, more preferably 1,000 to 50,000, and even more preferably 1,000 to 35,000.

In a case where the weight-average molecular weight of the rubber that is in a liquid form at room temperature is within the above range, it is easy to obtain a pressure sensitive adhesive layer having excellent step conformability, and the handleability of the composition for forming a pressure sensitive adhesive layer is improved.

In addition, in a case where the weight-average molecular weight of the rubber that is in a liquid form at room temperature is equal to or higher than 1,000, it is easy to obtain a pressure sensitive adhesive layer that has excellent adhesive force and is inhibited from flowing, leaking, and the like.

On the other hand, in a case where the weight-average molecular weight of the rubber that is in a liquid form at room temperature is equal to or lower than 100,000, the step conformability of the pressure sensitive adhesive layer tends to be excellent, and the handleability of the composition for forming a pressure sensitive adhesive layer is improved because the viscosity of the composition is not excessively increased.

Examples of the rubber that is in a liquid form at room temperature include unmodified or modified rubber. More specifically, examples of the rubber include natural rubber, (modified) polyisobutylene, (modified) polybutadiene, (modified) hydrogenated polyisoprene, (modified) hydrogenated polybutadiene, (modified) polyisoprene, (modified) polybutene, a (modified) styrene butadiene copolymer, a copolymer obtained by combining these randomly selected from the group consisting of the above rubbers, a mixture of these, and the like. In addition, “(modified) A” (“A” is a compound name) in the above examples is a generic term for both A modified with any group and unmodified A.

The rubber that is in a liquid form at room temperature may include rubber having a polymerizable group. The rubber having a polymerizable group is a type of modified rubber. Examples of such a polymerizable group include known radically polymerizable groups (such as a (meth)acryloyl group, an acrylamide group, a vinyl group, a vinylphenyl group, and an allyl group) and known cationically polymerizable groups (such as an epoxy group). Examples of a first rubber having a polymerizable group include rubber having a (meth)acryloyl group (such as polybutadiene, polyisoprene, hydrogenated polybutadiene, and hydrogenated polyisoprene). The rubber having a polymerizable group is not included in the polymerizable monomer which will be described later.

From the viewpoint of realizing a low dielectric constant and low temperature dependence, the rubber that is in a liquid form at room temperature preferably includes at least one kind of rubber selected from the group consisting of polybutadiene, polyisoprene, modified polybutadiene, and modified polyisoprene (preferably (meth)acrylic modified polyisoprene).

In view of further improving the effects of the present disclosure, the content of the rubber that is in a liquid form at room temperature with respect to the total mass of the composition for forming a pressure sensitive adhesive layer is preferably 5% by mass to 45% by mass and more preferably 10% by mass to 30% by mass.

<<Additive Rubber>>

The composition for forming a pressure sensitive adhesive layer may further contain additive rubber in addition to the rubber that is in a liquid form at room temperature.

The additive rubber is preferably rubber that has a weight-average molecular weight in a range of 250,000 to 2,000,000 and is in a solid form at room temperature (23° C.). In a case where the composition for forming a pressure sensitive adhesive layer further contains the additive rubber, a pressure sensitive adhesive layer having excellent moisture-heat adhesiveness is obtained.

In a case where the weight-average molecular weight of the additive rubber is equal to or higher than 250,000, the moisture-heat adhesiveness of the pressure sensitive adhesive layer is easily improved. In a case where the weight-average molecular weight of the additive rubber is equal to or lower than 2,000,000, it is easy to prepare the composition for forming a pressure sensitive adhesive layer.

Specific examples of the additive rubber will not be described because they are the same as the specific examples of the rubber that is in a liquid form at room temperature.

From the viewpoint of realizing a low dielectric constant and low temperature dependence, the additive rubber preferably includes at least one kind of rubber selected from the group consisting of polybutadiene, polyisoprene, modified polybutadiene, and modified polyisoprene (preferably (meth)acrylic modified polyisoprene).

The content of the additive rubber with respect to the total mass (100% by mass) of the composition for forming a pressure sensitive adhesive layer is equal to or greater than 10% by mass, and preferably 10% to 25% by mass.

As described above, in a case where the content of the additive rubber is equal to or greater than 10% by mass, a pressure sensitive adhesive layer having excellent moisture-heat adhesiveness is obtained. In a case where the content of the additive rubber is equal to or smaller than 25% by mass, the flexibility of the pressure sensitive adhesive layer is excellent, and thus the obtained pressure sensitive adhesive layer has further improved step conformability. In addition, during the preparation of the composition for forming a pressure sensitive adhesive layer, the solubility tends to be excellent.

On the other hand, in a case where the content of the additive rubber is less than 10% by mass, sometimes the moisture-heat adhesiveness of the pressure sensitive adhesive layer is insufficient.

<<Polymerizable Monomer>>

It is preferable that the composition for forming a pressure sensitive adhesive layer in the present disclosure contains a polymerizable monomer.

The polymerizable monomer is a compound having a polymerizable group. As the polymerizable group, known polymerizable groups can be used. Examples thereof include so-called radically polymerizable groups (such as a (meth)acryloyl group, an acrylamide group, a vinyl group, a vinylphenyl group, and an allyl group) and cationically polymerizable groups (such as an epoxy group).

Among these, as a polymerizable monomer, a (meth)acrylic monomer is preferable because this monomer has excellent handleability and excellent polymerization properties and can further improve the step conformability of the obtained pressure sensitive adhesive layer. Particularly, a monofunctional (meth)acrylic monomer is more preferable. By polymerizing the (meth)acrylic monomer, a (meth)acrylic polymer (poly(meth)acrylate) is obtained.

The (meth)acrylic monomer is a polymerizable monomer having a (meth)acryloyl group. Furthermore, the monofunctional (meth)acrylic monomer is a polymerizable monomer having one (meth)acryloyl group.

One kind of polymerizable monomer may be used singly, or two or more kinds of polymerizable monomers may be used in combination.

The type of the (meth)acrylic monomer is not particularly limited. However, in view of excellent handleability, a (meth)acrylic acid alkyl ester is preferable, and a monofunctional (meth)acrylic monomer represented by Formula (A) is more preferable.

CH₂═CHR¹—COO—R² Formula (A)

In Formula (A), R¹ represents a hydrogen atom or an alkyl group. The alkyl group preferably has 1 to 3 carbon atoms, and more preferably has 1 carbon atom.

R² represents a hydrocarbon group which may have a hetero atom.

Particularly, in view of further improving the step conformability of the obtained pressure sensitive adhesive layer, the number of carbon atoms (carbon number) in the hydrocarbon group represented by R² is preferably equal to or greater than 6, more preferably 6 to 16, and even more preferably 8 to 12.

As the hydrocarbon group, for example, an aliphatic hydrocarbon group, an aromatic hydrocarbon group, or a group obtained by combining these is preferable. The aliphatic hydrocarbon group may be linear, branched, or cyclic. More specifically, examples thereof include a linear aliphatic hydrocarbon group, a branched aliphatic hydrocarbon group, a cyclic aliphatic hydrocarbon group (an alicyclic hydrocarbon group), and the like.

Examples of the aliphatic hydrocarbon group include an alkyl group, a cycloalkyl group, an alkenyl group, and the like. Examples of the aromatic hydrocarbon group include a phenyl group, a naphthyl group, and the like.

The solubility parameter (SP value) of the (meth)acrylic monomer is not particularly limited. However, in view of further improving the effects of the present disclosure, the SP value is preferably 8.0 MPa^{1/2} to 10.0 MPa^{1/2}.

The SP value is a value calculated as described in Michael M. Collman, John F. Graf, Paul C. Painter (Pensylvania State Univ.), “Specific Interactions and the Miscibility of Polymer Blends” (1991), Technomic Publishing Co. Inc.

Specific examples of the (meth)acrylic monomer include n-octyl (meth)acrylate, isooctyl (meth)acrylate, n-nonyl (meth)acrylate, isononyl (meth)acrylate, n-decyl (meth)acrylate, and isodecyl (meth)acrylate, n-dodecyl (meth)acrylate, n-tridecyl (meth)acrylate, n-tetradecyl (meth)acrylate, n-hexadecyl (meth)acrylate, stearyl (meth)acrylate, benzyl (meth)acrylate, isobornyl (meth)acrylate, dicyclopentenyl (meth)acrylate, dicyclopentanyl (meth)acrylate, dicyclopentenyloxyethyl (meth)acrylate, and the like.

In view of further improving the effects of the present disclosure, examples of suitable aspects of the (meth)acrylic monomer include an aspect in which two or more kinds of (meth)acrylic monomers are used in combination. Among these, an aspect is more preferable in which a monomer X represented by Formula (A) wherein R² represents a chain-like aliphatic hydrocarbon group (preferably a branched aliphatic hydrocarbon group) and a monomer Y represented by Formula (A) wherein R² represents a cyclic aliphatic hydrocarbon group are used in combination.

Furthermore, from the viewpoint of improving the adhesiveness of the pressure sensitive adhesive layer, it is preferable that the composition for forming a pressure sensitive adhesive layer contains a monofunctional ethylenically unsaturated compound. Examples of the monofunctional ethylenically unsaturated compound include a monofunctional (meth)acrylate compound and a (meth)acrylic acid. For example, (meth)acrylic acid, benzyl (meth)acrylate, phenoxyethyl (meth)acrylate, butoxyethylene glycol (meth)acrylate, butoxydiethylene glycol (meth)acrylate, methoxytriethylene glycol (meth)acrylate, tetrahydrofurfuryl (meth)acrylate, 2-hydroxyethyl (meth)acrylate, 3-hydroxypropyl (meth)acrylate, 4-hydroxybutyl (meth)acrylate, tetraethylene glycol monomethyl ether (meth)acrylate, hexaethylene glycol monomethyl ether (meth)acrylate, octaethylene glycol monomethyl ether (meth)acrylate, nonaethylene glycol methyl ether (meth)acrylate, heptapropylene glycol monomethyl ether (meth)acrylate, tetraethylene glycol ethyl ether (meth)acrylate, tetraethylene glycol mono(meth)acrylate, hexaethylene glycol mono(meth)acrylate, octapropylene glycol mono(meth)acrylate, glycidyl (meth)acrylate, 4-Hydroxybutyl (meth)acrylate glycidyl ether, 3,4-epoxycyclohexylmethyl (meth)acrylate, N,N-dimethyl (meth)acrylamide, N,N-diethyl (meth)acrylamide, N-t-butyl (meth)acrylamide, N,N-isopropyl (meth)acrylamide, N-t-octyl(meth)acrylamide, N,N-dimethylaminoethyl(meth)acrylamide, N,N-dimethylaminopropyl (meth)acrylamide, diacetone acrylamide, (meth)acryloylmorpholine, N-vinylpyrrolidone, N-vinylcaprolactam, and the like are preferable.

In a case where the composition for forming a pressure sensitive adhesive layer contains a monofunctional ethylenically unsaturated compound, the content of the compound is not particularly limited. The content of the compound with respect to the total mass of the composition for forming a pressure sensitive adhesive layer is preferably 0.1% by mass to 10% by mass, and more preferably 0.5% by mass to 3% by mass.

Furthermore, it is preferable that the pressure sensitive adhesive layer contains a polyfunctional ethylenically unsaturated compound. Examples of the polyfunctional ethylenically unsaturated compound include a polyfunctional (meth)acrylate compound.

Examples of the polyfunctional (meth)acrylate include ethylene glycol (meth)acrylate, difunctional (meth)acrylate such as 1,6-hexanediol di(meth)acrylate, 1,9-nonanediol di(meth)acrylate, polypropylene glycol di (meth)acrylate, tetraethylene glycol di(meth)acrylate, bisphenoxyethanol fluorene diacrylate, and bisphenoxyethanol fluorene diacrylate, and (meth)acrylate having 3 or more functional groups such as trimethylolpropane tri(meth)acrylate, pentaerythritol tri(meth)acrylate, tri(meth)acryloyloxyethyl)phosphate, pentaerythritol tetra(meth)acrylate, dipentaerythritol penta(meth)acrylate, dipentaerythritol hexa(meth)acrylate, and a urethane acrylate oligomer, and the like.

In a case where the composition for forming a pressure sensitive adhesive layer contains the polyfunctional ethylenically unsaturated compound, the content of the compound is not particularly limited. The content of the polyfunctional ethylenically unsaturated compound with respect to the total mass (100% by mass) of the composition for forming a pressure sensitive adhesive layer is preferably 0.01% to 2% by mass, and more preferably 0.1% to 1% by mass.

The content of the polymerizable monomer is not particularly limited. The content of the polymerizable monomer with respect to the total mass of the composition for forming a pressure sensitive adhesive layer is preferably 10% by mass to 45% by mass, more preferably 15% by mass to 30% by mass, and even more preferably 20% by mass to 30% by mass.

—Photopolymerization Initiator—

The composition for forming a pressure sensitive adhesive layer in the present disclosure may contain a photopolymerization initiator.

The type of photopolymerization initiator is not particularly limited, and known photopolymerization initiators (a radical photopolymerization initiator and a cationic photopolymerization initiator) can be used. Examples of the photopolymerization initiator include an alkylphenone-based photopolymerization initiator, a methoxyketone-based photopolymerization initiator, an acylphosphine oxide-based photopolymerization initiator, a hydroxyketone-based photopolymerization initiator (for example, IRGACURE 184; 1,2-α-hydroxyalkylphenone), an aminoketone-based photopolymerization initiator (for example, 2-methyl-1-[4-(methylthio)phenyl]-2-morpholino-propan-1-one (IRGACURE (registered trademark) 907)), and an oxime-based photopolymerization initiator (for example, IRGACURE OXE-01).

Among these, as the photopolymerization initiator, an acylphosphine oxide-based photopolymerization initiator is preferable. It is more preferable that the composition contains at least one compound selected from the group consisting of monoacylphosphine oxide and bisacylphosphine oxide.

Specific examples of the monoacylphosphine oxide include benzoyl-diphenylphosphine oxide, 2,4,6-trimethylbenzoyl-diphenylphosphine oxide, 2,3,5,6-tetramethylbenzoyl-diphenylphosphine oxide, 3,4-dimethylbenzoyl-diphenylphosphine oxide, 2,4,6-trimethylbenzoyl-phenylethoxyphosphine oxide, and the like.

Specific examples of the bisacylphosphine oxide include bis(2,4,6-trimethylbenzoyl)-phenylphosphine oxide, bis(2,6-dimethoxybenzoyl)-2,4,4-trimethyl-pentylphosphine oxide, bis(2,6-dimethylbenzoyl)-ethylphosphine oxide, and the like.

One kind of photopolymerization initiator may be used singly, or two or more kinds of photopolymerization initiators may be used in combination.

The content of the photopolymerization initiator is not particularly limited. The content of the photopolymerization initiator with respect to the total mass of the composition for forming a pressure sensitive adhesive layer is preferably 1.0% by mass to 5.0% by mass, and more preferably 1.5% by mass to 4.0% by mass.

—Viscosity Imparting Agent—

It is preferable that the composition for forming a pressure sensitive adhesive layer in the present disclosure contains a viscosity imparting agent.

As the viscosity imparting agent, those known in the field of patch or patch preparation may be appropriately selected and used. Examples of the viscosity imparting agent include a petroleum resin (such as an aromatic petroleum resin, an aliphatic petroleum resin, or a resin made of a C9 fraction), a terpene-based resin (for example, an α-pinene resin, a β-pinene resin, a terpene resin, a terpene phenol copolymer, a hydrogenated terpene phenol resin, an aromatic modified hydrogenated terpene resin, an aromatic modified terpene resin, or an abietic acid ester resin), a rosin-based resin (for example, a partially hydrogenated gum rosin resin, an erythritol modified wood rosin resin, a tall oil rosin resin, or a wood rosin resin), a coumarone indene resin (for example, a coumarone-indene-styrene copolymer), a styrene-based resin (such as polystyrene or a copolymer of styrene and α-methylstyrene), and the like. As the viscosity imparting agent, for example, a petroleum-based resin, a terpene-based resin, and a styrene-based resin that do not contain a polar group are more preferable. Among these, the terpene-based resin is most preferable.

The terpene-based resin is preferably a terpene resin or a hydrogenated terpene resin, and most preferably a hydrogenated terpene resin.

As such a terpene-based resin, commercially available products can be used. Specific examples thereof include CLEARON P150, CLEARON P135, CLEARON P125, CLEARON P115, CLEARON P105, and CLEARON P85 (manufactured by YASUHARA CHEMICAL CO., LTD.), and the like.

One kind of viscosity imparting agent may be used singly, or two or more kinds of viscosity imparting agents may be used in combination.

In view of further improving the effects according to the present disclosure, the content of the viscosity imparting agent with respect to the total mass (100% by mass) of the composition for forming a pressure sensitive adhesive layer is preferably 5% by mass to 50% by mass and more preferably 20% by mass to 45% by mass.

Furthermore, in view of further improving the effects according to the present disclosure, the content of the viscosity imparting agent with respect to the total mass of the pressure sensitive adhesive layer is preferably 5% by mass to 50% by mass and more preferably 20% by mass to 45% by mass.

—Antioxidant—

It is preferable that the composition for forming a pressure sensitive adhesive layer in the present disclosure contains an antioxidant.

In a case where the composition contains an antioxidant, it is possible to inhibit the polymerizable group contained in the polymerizable monomer and the like from reacting during the preparation of the composition for forming a pressure sensitive adhesive layer. Accordingly, the adhesiveness of the pressure sensitive adhesive layer can be improved.

Examples of the antioxidant include a phenolic antioxidant, a hydroquinone-based antioxidant, a phosphorus-based antioxidant, a hydroxylamine-based antioxidant, and the like.

Examples of the phenolic or hydroquinone-based antioxidant include 2,6-di-tert-butyl-4-methylphenol, 4,4′-thiobis-(6-tert-butyl-3-methylphenol), 1, 1′-bis(4-hydroxyphenyl)cyclohexane, 2,2′-methylenebis(4-ethyl-6-tert-butylphenol), 2,5-di-tert-butylhydroquinone, pentaerythrityl-tetrakis[3-(3,5-di-tert-butyl-4-hydroxyphenyl)propionate], and the like.

Examples of phosphorus-based antioxidant include phosphite-based antioxidants such as tris(4-methoxy-3,5-diphenyl)phosphite, tri s(nonylphenyl)phosphite, tris(2,4-di-tert-butylphenyl)phosphite, bis(2,6-di-tert-butyl-4-methylphenyl)pentaerythritol diphosphite, and bis(2,4-di-tert-butylphenyl)pentaerythritol diphosphite.

Examples of the hydroxylamine-based antioxidant include N,N-dioctadecylhydroxylamine, N,N-dibenzylhydroxylamine, and the like.

Among these, the phosphorus-based antioxidant is preferably used, and a phosphite-based antioxidant is more preferably used, because these antioxidants enable the effects described above to be further exhibited and less hinder polymerization.

One kind of antioxidant may be used singly, or two or more kinds of antioxidants may be used in combination.

—Other Components—

<<Chain Transfer Agent>>

The composition for forming a pressure sensitive adhesive layer in the present disclosure may contain a chain transfer agent. The type of the chain transfer agent is not particularly limited, and known chain transfer agents (such as 1-dodecanethiol, trimethylolpropane tristhiopropionate, and pentaerythritol tetrakisthiopropionate) are used.

<<Crosslinker>>

The composition for forming a pressure sensitive adhesive layer in the present disclosure may further contain a crosslinker.

As the crosslinker, for example, an isocyanate-based crosslinker, an epoxy-based crosslinker, a polyfunctional (meth)acrylate, and the like can be used.

Examples of the isocyanate-based crosslinker include 2,4-tolylene diisocyanate, 2,6-tolylene diisocyanate, hydrogenated tolylene diisocyanate, 1,3-xylylene diisocyanate, 1,4-xylylene diisocyanate, hexamethylene diisocyanate, diphenylmethane-4,4-diisocyanate, isophorone diisocyanate, 1,3-bis(isocyanatomethyl)cyclohexane, tetramethylxylylene diisocyanate, 1,5-naphthalene diisocyanate, triphenylmethane triisocyanate, adducts of these polyisocyanate compounds and polyol compounds such as trimethylolpropane, Biuret compounds or isocyanurate compounds of these polyisocyanate compounds, and the like. Among the isocyanate-based crosslinkers, 2,4-tolylene diisocyanate, 2,6-tolylene diisocyanate, 1,3-xylylene diisocyanate, 1,4-xylylene diisocyanate, hexamethylene diisocyanate, and isophorone diisocyanate are preferable from the viewpoint of the dielectric constant of the pressure sensitive adhesive layer, and hexamethylene diisocyanate and isophorone diisocyanate are more preferable from the viewpoint of coloration over time.

The isocyanate group in these isocyanate-based crosslinkers may be blocked using a known blocking agent. The decomposition temperature thereof is preferably 100° C. to 130° C.

Examples of the epoxy-based crosslinker include a bisphenol A/epichlorohydrin-type epoxy resin, ethylene glycol diglycidyl ether, polyethylene glycol diglycidyl ether, glycerin diglycidyl ether, glycerin triglycidyl ether, 1,6-hexanediol diglycidyl ether, trimethylolpropane triglycidyl ether, sorbitol polyglycidyl ether, polyglycerol polyglycidyl ether, pentaerythritol polyglycidyl erythritol, diglycerol polyglycidyl ether, and the like. Among the epoxy-based crosslinkers, ethylene glycol diglycidyl ether, polyethylene glycol diglycidyl ether, 1,6-hexanediol diglycidyl ether, and trimethylolpropane triglycidyl ether are preferable from the viewpoint of flexibility of the pressure sensitive adhesive layer, and 1,6-hexanediol diglycidyl ether and trimethylolpropane triglycidyl ether are more preferable from the viewpoint of dielectric constant.

In a case where the composition for forming a pressure sensitive adhesive layer contains a crosslinker, the content of the crosslinker is not particularly limited. The content of the crosslinker with respect to the total mass (100% by mass) of the composition for forming a pressure sensitive adhesive layer is preferably 0.01% to 2% by mass, and more preferably 0.1% to 1% by mass.

One kind of each of crosslinkers described above may be used singly, or two or more kinds of crosslinkers described above may be used in combination.

<<Anticorrosive>>

In order to prevent the corrosion of the transparent electrode or prevent the corrosion of routing wiring, it is preferable that the pressure sensitive adhesive layer or the metal oxide particle-containing layer contains an azole compound having an azole structure. The molecular weight of the azole compound is preferably equal to or higher than 60 and equal to or lower than 1,000. It is preferable that the pressure sensitive adhesive layer or the metal oxide particle-containing layer contains at least one kind of azole compound (hereinafter, also referred to as specific azole compound) selected from the group consisting of an imidazole compound, a triazole compound, a tetrazole compound, a thiazole compound, and a thiadiazole compound among azole compounds.

In the present specification, “imidazole compound” means a compound having an imidazole structure, “triazole compound” means a compound having a triazole structure, “tetrazole compound” means a compound having a tetrazole structure, “thiazole compound” means a compound having a thiazole structure, and “thiadiazole compound” means a compound having a thiadiazole structure.

In a case where the pressure sensitive adhesive layer or the metal oxide particle-containing layer contains the specific azole compound, it is possible to inhibit the discoloration of wiring for a touch panel.

The specific azole compound is not particularly limited.

Specific examples of the specific azole compound are listed in the following Tables 1 and 2. However, the specific azole compound in the present disclosure is not limited thereto.

In Tables 1 and 2, in addition to the compound names, the categories and structural formulas of the compounds, pKa of conjugate acids, and examples of commercially available products are listed.

TABLE 1

| | | | pKa of |
|---|---|---|---|
| Compound name | Structural formula | Type | conjugate acid |
| Benzimidazole (Tokyo Chemical Industry Co., Ltd.) | 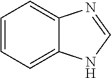 | Imidazole compound | 5.67 |
| 2-Methylimidazole (Trade name: 2MZ-H, SHIKOKU CHEMICALS CORPORATION) | 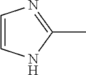 | Imidazole compound | 8.15 |
| 2-Mercaptobenzimidazole (Trade name: MB, Kawaguchi Chemical Industry Co., Ltd.) | 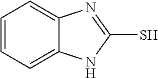 | Imidazole compound | 2.38 |
| 5-Amino-2-mercaptobenzimidazole (Tokyo Chemical Industry Co., Ltd.) | 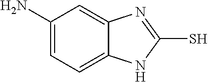 [SMILES: Nc1ccc2[nH]c(S)nc2c1] | Imidazole compound | 3.02 |
| 5-Methylimidazole (Tokyo Chemical Industry Co., Ltd.) | 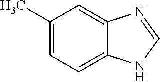 | Imidazole compound | 5.98 |
| 1,2,3-Benzotriazole (Trade name: BT-120, JOHOKU CHEMICAL CO., LTD) | 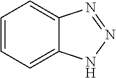 | Triazole compound | 1.17 |
| 1-[N,N-bis(2-ethylhexyl)aminomethyl]benzotriazole (Trade name: BT-LX, JOHOKU CHEMICAL CO., LTD) | 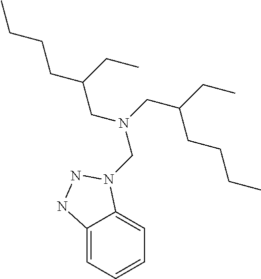 [SMILES: CCCCC(CC)CN(CC(CC)CCCC)CN1NNc2ccccc21] | Triazole compound | 6.68 |
| 3-Mercapto-1,2,4-triazole (Trade name: 3MT, Otsuka Chemical Co., Ltd.) | 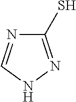 | Triazole compound | 1.30 |
| 3-Amino-5-methylthio-1H-1,2,4-triazole (Tokyo Chemical Industry Co., Ltd.) | 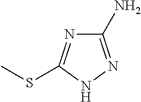 | Triazole compound | 2.99 |
| Carboxybenzotriazole (Trade name: CBT-1, JOHOKU CHEMICAL CO., LTD) | 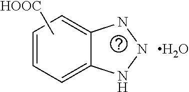 | Triazole compound | −0.06 |
| 2,2′-[[(Methyl-1H-benzotriazol-1-yl)methyl]imino]bisethanol (Trade name: TT-LYK, JOHOKU CHEMICAL CO., LTD) | 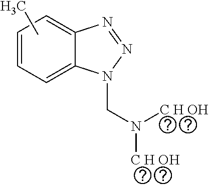 | Triazole compound | 5.51 |
| 1-(2,3-Dicarboxypropyl)benzotriazole (Trade name: BT-250, JOHOKU CHEMICAL CO., LTD) | 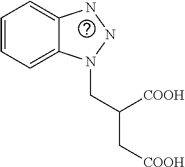 [SMILES: O=C(O)CC(CN1NNc2ccccc21)C(=O)O] | Triazole compound | 1.21 |
| 1-[(2-Ethylhexyl)methyl]benzotriazole (Trade name: BT 260, JOHOKU CHEMICAL CO., LTD) | 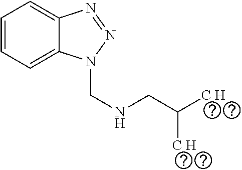 | Triazole compound | 7.74 |
| 2,6-Bis[(1H-benzotriazol-1-yl)methyl]-4-methylphenol (Trade name: BT 3700, JOHOKU CHEMICAL CO., LTD) | 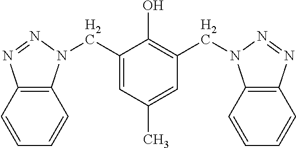 [SMILES: Cc1cc(Cn2nnc3ccccc32)c(O)c(Cn2nnc3ccccc32)c1] | Triazole compound | 1.49 |

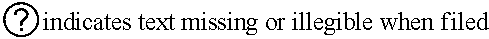

TABLE 2

| | | | pKa of |
|---|---|---|---|
| Compound name | Structural formula | Type | conjugate acid |
| 1-(1′,2′-Dicarboxyethyl)benzotriazole (Trade name: BT-M, JOHOKU CHEMICAL CO., LTD) | 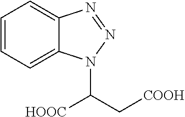 [SMILES: O=C(O)CC(C(=O)O)n1nnc2ccccc21] | Triazole compound | 0.09 |
| 1,2,4-Triazole (Tokyo Chemical Industry Co., Ltd.) | 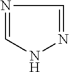 | Triazole compound | 2.70 |
| 1,2,3-Triazole (Tokyo Chemical Industry Co., Ltd.) | 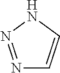 | Triazole compound | 1.17 |
| 5-Amino-1H-tetrazole (Trade name: HAT, TOYOBO CO., LTD.) | 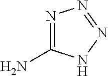 | Tetrazole compound | 1.29 |
| 1H-Tetrazole (Trade name: 1-HT, TOYOBO CO., LTD.) | 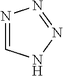 | Tetrazole compound | −3.02 |
| 1-Methyl-5-mercaptotetrazole (Trade name: MMT, TOYOBO CO., LTD.) | 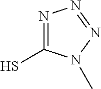 | Tetrazole compound | −2.98 |
| 5-Mercapto-1-phenyl-1H-tetrazole (Trade name: PMT, TOYOBO CO., LTD.) | 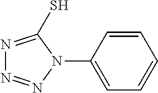 [SMILES: Sc1nnnn1-c1ccccc1] | Tetrazole compound | −4.56 |
| 5-Phenyl-1H-tetrazole (Trade name: P5T, TOYOBO CO., LTD.) | 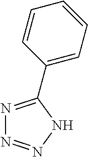 [SMILES: c1ccc(-c2nnn[nH]2)cc1] | Tetrazole compound | −2.88 |
| 2-Aminobenzothiazole (Tokyo Chemical Industry Co., Ltd.) | 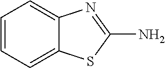 | Thiazole compound | 4.65 |
| 1,3,4-Thiadiazole-2,5-dithiol (Trade name: MTD, TOYOBO CO., LTD.) | 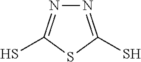 | Thiadiazole compound | −2.11 |
| 2-Mercapto-5-methylthio-1,3,4-thiadiazole (Tokyo Chemical Industry Co., Ltd.) | 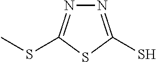 | Thiadiazole compound | −1.32 |
| 2-Mercapto-1,3,4-thiadiazole (Tokyo Chemical Industry Co., Ltd.) | 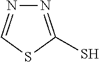 | Thiadiazole compound | −1.09 |
| 2-Amino-5-methylthio-1,3,4-thiadiazole (Tokyo Chemical Industry Co., Ltd.) | 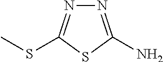 | Thiadiazole compound | 2.12 |
| 5-Amino-1,2,3-thiadiazole (Tokyo Chemical Industry Co., Ltd.) | 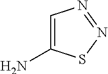 | Thiadiazole compound | 0.34 |

Specific examples of the specific azole compound also include imidazole compounds such as 1-methylimidazole, 4-methylimidazole, 2-mercapto-1-methylimidazole, 2-phenylimidazole, 2-ethyl-4-methylimidazole, imidazole, 5,6-dimethylbenzimidazole, 5-ethoxy-2-mercaptobenzimidazole, 2-phenylimidazole, 2-mercapto-5-methylbenzimidazole, 2-mercapto-5-methoxybenzimidazole, 2-mercapto-5-benzimidazole carboxylic acid, 2-(4-thiazolyl)benzimidazole, 2-amino-1-methylbenzimidazole, 2-aminobenzimidazole, 1-(3-aminopropyl)imidazole, 6-aminobenzimidazole, and 5-aminobenzimidazole.

Among these, as the specific azole compound, from the viewpoint of further inhibiting the discoloration of wiring for a touch panel, at least one kind of azole compound selected from the group consisting of a triazole compound and a tetrazole compound is preferable, at least one kind of azole compound selected from the group consisting of 1,2,3-triazole, 1,2,4-triazole, 1,2,3-benzotriazole, and 5-amino-1H-tetrazole is more preferable, and at least one kind of azole compound selected from the group consisting of 1,2,3-benzotriazole and 5-amino-1H-tetrazole is even more preferable.

It is preferable that the routing wiring is copper because then the effect of the specific azole compound described above is markedly exhibited.

<<Other Components>>

In addition to the above components, various known additives such as a solvent (such as water or an organic solvent), a polymerization inhibition suppressant, a surface lubricant, a leveling agent, a light stabilizer, an ultraviolet absorber, a polymerization inhibitor, a silane coupling agent, an inorganic or organic filler, metal powder, powder of a pigment or the like, a particle-like substance, and a foil-like substance can be appropriately added to the composition for forming a pressure sensitive adhesive layer in the present disclosure according to the use.

[Thickness]

The thickness of the pressure sensitive adhesive layer is preferably 5 μm to 200 μm, and more preferably 25 μm to 100 μm.

<Temporary Support>

The transfer film of the present disclosure includes a temporary support.

The temporary support is preferably a film, and more preferably a resin film.

The temporary support is preferably transparent.

As the temporary support, it is possible to use a film that is flexible and is not significantly deformed, shrinks, or is stretched under pressure or under pressure with heating.

Examples of such a film include a polyethylene terephthalate film, a cellulose triacetate film, a polystyrene film, a polyimide film, and a polycarbonate film.

Among these, a biaxially stretched polyethylene terephthalate film is particularly preferable.

The thickness of the temporary support is not particularly limited, but is preferably 5 μm to 200 μm. From the viewpoint of ease of handling and versatility, the thickness of the temporary support is particularly preferably 10 μm to 150 μm.

<Interlayer>

From the viewpoint of preventing the components from being mixed together during the coating of a plurality of layers and during the storage following the coating, an interlayer may be further provided between the metal oxide particle-containing layer and the pressure sensitive adhesive layer in the transfer film according to the present disclosure.

As the interlayer, the oxygen barrier film functioning as an oxygen barrier that is described as “separation layer” in JP1993-072724A (JP-H05-072724A) is preferable. In a case where such an interlayer is used, the sensitivity for exposure is increased, the hours of use of an exposure machine can be reduced, and productivity is improved.

<Protective Film>

It is preferable that a protective film (protective release layer) or the like is further provided on a surface of the metal oxide particle-containing layer in the transfer film according to the present disclosure.

The protective film is preferably an acrylic resin film or a polypropylene resin film. The thickness of the protective film is preferably 12 μm to 40 μm.

The films described in paragraphs “0083” to “0087” and “0093” of JP2006-259138A can be appropriately used.

<Method for Manufacturing Transfer Film>

The transfer film according to the present disclosure is not particularly limited. However, it is preferable that the transfer film is manufactured, for example, by the following method for manufacturing a transfer film according to the present disclosure.

The method for manufacturing a transfer film according to the present disclosure has a step of forming a pressure sensitive adhesive layer on a temporary support and a step of forming a metal oxide particle-containing layer on the pressure sensitive adhesive layer.

[Step of Forming Pressure Sensitive Adhesive Layer]

The pressure sensitive adhesive layer is obtained by at least either curing or drying of the composition for forming a pressure sensitive adhesive layer described above.

That is, the pressure sensitive adhesive layer is formed by applying the composition for forming a pressure sensitive adhesive layer to a temporary support and then performing at least either a curing treatment or a drying treatment.

The composition for forming a pressure sensitive adhesive layer is applied, for example, by a method such as coating using a gravure coater, a comma coater, a bar coater, a knife coater, a die coater, a roll coater, or the like. The above method is not limited to coating as long as the composition for forming a pressure sensitive adhesive layer can be applied to the temporary support, and other known methods can be used.

As the curing treatment, an appropriate method may be selected according to the composition of the composition for forming a pressure sensitive adhesive layer or the like. Examples of the curing treatment include a photocuring treatment, a thermal curing treatment, and the like.

The photocuring treatment may include a plurality of curing steps, and the wavelength of light to be used may be appropriately selected from a plurality of wavelengths. Furthermore, the thermal curing treatment may include a plurality of curing steps, and the method of applying heat may be selected from appropriate methods such as an oven, a reflow furnace, and an infrared heater. In addition, the photocuring treatment and the thermal curing treatment may be appropriately combined.

The light source used for the photocuring treatment is not particularly limited, and examples thereof include a low-pressure mercury lamp, a medium-pressure mercury lamp, a high-pressure mercury lamp, an ultrahigh-pressure mercury lamp, a xenon lamp, a metal halide lamp, an electrodeless lamp, and the like. The light used for the photocuring treatment is preferably ultraviolet light. For example, a general ultraviolet irradiation device, and more specifically, a belt conveyor-type ultraviolet irradiation device is preferably used.

The conditions for the photocuring treatment are appropriately selected according to the components of a composition to be used or the like. The irradiation dose (for example, ultraviolet irradiation dose) is preferably 100 mJ/cm² to 2,500 mJ/cm², and more preferably 200 mJ/cm² to 1,100 mJ/cm².

The exposure may be carried out after the influence of oxygen is reduced, for example, by sticking a release sheet to the surface of the applied composition for forming a pressure sensitive adhesive layer or by performing the exposure in an inert gas atmosphere.

The drying treatment is not particularly limited, and examples thereof include methods such as natural drying, air drying using a device such as a blower, and drying by heating using a device such as a hot plate or an oven.

In the present disclosure, drying means a treatment of removing at least a portion of the solvent contained in the composition.

[Step of Forming Metal Oxide Particle-Containing Layer]

For example, by mixing the components to be incorporated into the aforementioned metal oxide particle-containing layer with a known solvent so as to obtain a composition for forming a metal oxide particle-containing layer, and applying the composition onto the pressure sensitive adhesive layer, the metal oxide particle-containing layer is obtained. Furthermore, by transferring the metal oxide particle-containing layer onto the pressure sensitive adhesive layer, the metal oxide particle-containing layer is obtained.

The composition for forming a metal oxide particle-containing layer is applied onto the pressure sensitive adhesive layer, for example, by the same method as the method of applying the composition for forming a pressure sensitive adhesive layer described above.

After being applied, the composition for forming a metal oxide particle-containing layer is dried, thereby obtaining a metal oxide particle-containing layer. The drying method is not particularly limited, and for example, known methods such as the natural drying, air drying, and drying by heating described above are used.

[Other Steps]

In addition, the method for manufacturing a transfer film according to the present disclosure may further include a step of providing a protective film, a step of providing an interlayer, and the like.

For details of these steps, the description in JP2014-108541A can be referred to.

In the transfer film of the present disclosure, a transmittance of the pressure sensitive adhesive layer and the metal oxide particle-containing layer at a wavelength of 400 nm is preferably equal to or higher than 85%, and more preferably equal to or higher than 90%.

(Laminate)

The laminate according to the present disclosure has a transparent electrode pattern, a metal oxide particle-containing layer that is disposed adjacent to the transparent electrode pattern and contains metal oxide particles, and a pressure sensitive adhesive layer that is disposed adjacent to the metal oxide particle-containing layer in this order. In the metal oxide particle-containing layer, a variation of the content of the metal oxide particles is equal to or lower than 10% in the film thickness direction.

According to the laminate of the present disclosure, the visibility of the transparent electrode pattern is reduced.

[WVTR]

In the laminate according to the present disclosure, from the viewpoint of inhibiting the corrosion of the transparent electrode pattern and metal wiring (such as copper wiring), WVTR of a layer as a combination of the pressure sensitive adhesive layer and the metal oxide particle-containing layer at 60° C. is preferably equal to or lower than 1,100 g/(m²·day), more preferably 200 g/(m²·day) to 600 g/(m²·day), and even more preferably 200 g/(m²·day) to 400 g/(m²·day).

<Structure of Laminate>

[Pressure sensitive adhesive layer and metal oxide particle-containing layer]

The preferred ranges of the pressure sensitive adhesive layer and metal oxide particle-containing layer are the same as the preferred ranges of the pressure sensitive adhesive layer and metal oxide particle-containing layer in the transfer film according to the present disclosure.

From the viewpoint of further improving the visibility of the transparent electrode pattern, it is preferable that the laminate according to the present disclosure has a transparent film which has a refractive index of 1.60 to 1.78 and a film thickness equal to or greater than 30 nm and equal to or smaller than 300 nm, on one side of the transparent electrode pattern that is opposite to the other side thereof on which the metal oxide particle-containing layer is formed. In the present disclosure, unless otherwise specified, “transparent film” refers to “transparent film which has a refractive index of 1.60 to 1.78 and a film thickness equal to or greater than 30 nm and equal to or smaller than 300 nm” described above. The film thickness of the transparent film is more preferably 55 nm to 110 nm.

It is preferable that the laminate according to the present disclosure further has a transparent base material on one side of the transparent film, which has a refractive index of 1.60 to 1.78 and a film thickness equal to or greater than 30 nm and equal to or smaller than 300 nm, opposite to the other side thereof on which the transparent electrode pattern is formed.

FIG. 2 shows an example of a preferred aspect (also referred to as “aspect A”) of the laminate according to the present disclosure.

In FIG. 2, the laminate has a transparent base material 1 and a transparent film 11 which has a refractive index of 1.60 to 1.78 and a film thickness equal to or greater than 30 nm and equal to or smaller than 300 nm, and further has an in-plane region in which a transparent electrode pattern 4, a metal oxide particle-containing layer 12, and a pressure sensitive adhesive layer 18 are laminated in this order.

“In-plane” means a direction substantially parallel to the plane parallel to the transparent base material of the laminate. Having the in-plane region in which the transparent electrode pattern 4, the metal oxide particle-containing layer 12, and the pressure sensitive adhesive layer 18 are laminated in this order means that an orthograph projected on a plane parallel to the transparent base material of the laminate in the region in which the transparent electrode pattern 4, the metal oxide particle-containing layer 12, and the pressure sensitive adhesive layer 18 are laminated in this order is present within the plane parallel to the transparent base material of the laminate.

In a case where the laminate according to the present disclosure is used in a capacitive input device which will be described later, as the transparent electrode pattern, sometimes a first transparent electrode pattern and a second transparent electrode pattern are provided along two directions, a horizontal direction and a vertical direction, which are substantially orthogonal to each other (for example, see FIG. 5). For example, in the constitution shown in FIG. 5, the transparent electrode pattern in the laminate according to the present disclosure may be a second transparent electrode pattern 4 or a pad portion 3a of a first transparent electrode pattern 3. In other words, in the following description of the laminate according to the present disclosure, although the transparent electrode pattern is typically represented by a reference “4”, the transparent electrode pattern in the laminate according to the present disclosure is not used only as the second transparent electrode pattern 4 in the capacitive input device according to the present disclosure and may be used, for example, as the pad portion 3a of the first transparent electrode pattern 3.

It is preferable that the laminate according to the present disclosure includes a non-patterned region in which the transparent electrode pattern is not formed. In the present disclosure, the non-patterned region means a region in which the transparent electrode pattern 4 is not formed.

FIG. 3 shows an aspect in which the laminate according to the present disclosure includes a non-patterned region 22.

It is preferable that the laminate according to the present disclosure includes an in-plane region in which the transparent base material, transparent film, and metal oxide particle-containing layer described above are laminated in this order, in at least a portion of the non-patterned region 22 in which the transparent electrode pattern is not formed.

It is preferable that the transparent film and metal oxide particle-containing layer in the laminate according to the present disclosure are adjacent to each other in the region in which the transparent film, the transparent base material, and the metal oxide particle-containing layer are laminated in this order.

In other regions of the non-patterned region 22, other members may be disposed at any position unless doing such a thing goes against the object of the present disclosure. For example, in a case where the laminate according to the present disclosure is used in the capacitive input device which will be described later, a mask layer 2, an insulating layer 5, and a conductive element 6 in FIG. 2 and the like can be laminated.

It is preferable that the transparent base material and transparent film in the laminate according to the present disclosure are adjacent to each other.

FIG. 2 shows an aspect in which the transparent film 11 is laminated adjacent to the transparent base material 1.

The thickness of the transparent film in the laminate according to the present disclosure is 55 nm to 110 nm, preferably 60 nm to 110 nm, and more preferably 70 nm to 90 nm.

The transparent film may have a single-layer structure or a laminated structure consisting of two or more layers. In a case where the transparent film has a laminated structure consisting of two or more layers, the film thickness of the transparent film means the total film thickness of all layers.

It is preferable that the transparent film and transparent electrode pattern in the laminate according to the present disclosure are adjacent to each other.

FIG. 2 shows an aspect in which the transparent electrode pattern 4 is laminated adjacent to a partial region of the transparent film 11.

As shown in FIG. 2, the edge of the transparent electrode pattern 4 may have a tapered shape although the shape is not particularly limited. For example, the edge of the transparent electrode pattern 4 may have a tapered shape such that a face of the transparent electrode pattern 4 contacting the transparent base material side is wider than a surface of the pattern 4 opposite to the transparent base material.

In a case where the edge of the transparent electrode pattern has a tapered shape, an angle of the edge of the transparent electrode pattern (hereinafter, also referred to as taper angle) is preferably equal to or smaller than 30°, more preferably 0.1° to 15°, and particularly preferably 0.5° to 5°.

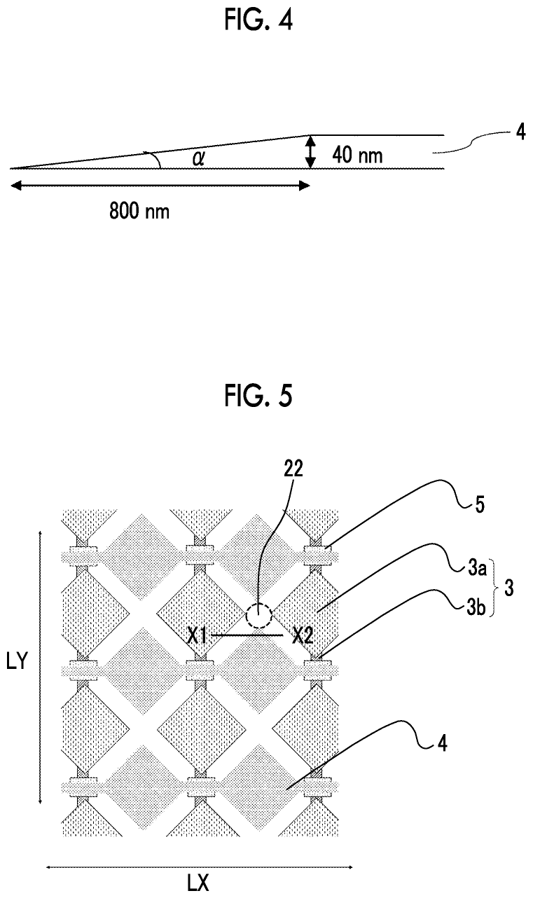

In the present disclosure, the taper angle can be measured by a method of taking a micrograph of the edge of the transparent electrode pattern, approximating a tapered portion in the micrograph to a triangle, and directly measuring the taper angle thereof FIG. 4 shows an example case where the edge of the transparent electrode pattern has a tapered shape. In FIG. 4, the triangle obtained by the approximation of a tapered portion has an 800 nm-long base and a height (film thickness measured from the upper base portion substantially parallel to the base) of 40 nm. The tapered angle of this triangle is about 3°. The length of the base of the triangle obtained by the approximation of a tapered portion is preferably 10 nm to 3000 nm, more preferably 100 nm to 1,500 nm, and particularly preferably 300 nm to 1,000 nm. The preferred range of the height of the triangle obtained by the approximation of a tapered portion is the same as the preferred range of the film thickness of the transparent electrode pattern.

It is preferable that the laminate according to the present disclosure includes an in-plane region in which the transparent electrode pattern and the metal oxide particle-containing layer are adjacent to each other.

FIG. 3 shows an aspect in which the transparent electrode pattern, the metal oxide particle-containing layer, and the pressure sensitive adhesive layer are adjacent to each other in a region 21 in which the transparent electrode pattern, the metal oxide particle-containing layer, and the pressure sensitive adhesive layer are laminated in this order.

In addition, in the laminate according to the present disclosure, it is preferable that the transparent electrode pattern and the non-patterned region 22 in which the transparent electrode pattern is not formed continue and are both coated with the transparent film and the metal oxide particle-containing layer directly or through another layer.

Herein, “continue” means that the transparent film and the metal oxide particle-containing layer are not a patterned film but a continuous film. That is, from the viewpoint of making it difficult for the transparent electrode pattern to be seen, it is preferable that the transparent film and the metal oxide particle-containing layer do not have an opening portion.

Furthermore, it is preferable that the transparent electrode pattern and the non-patterned region 22 are directly coated with the transparent film and the metal oxide particle-containing layer without the intervention of another layer. In a case where the transparent electrode pattern and the non-patterned region 22 are coated with the transparent film and the metal oxide particle-containing layer through another layer, examples of “another layer” include an insulating layer 5 included in the capacitive input device according to the present disclosure that will be described later, a transparent electrode pattern as a second layer in a capacitive input device having two or more transparent electrode pattern layers just as the capacitive input device according to the present disclosure that will be described later, and the like.

In the aspect shown in FIG. 3, the metal oxide particle-containing layer 12 is laminated adjacent to both the region on the transparent film 11 on which the transparent electrode pattern 4 is not laminated and the transparent electrode pattern 4 so as to cover both the aforementioned region and the transparent electrode pattern 4.

In a case where the edge of the transparent electrode pattern 4 has a tapered shape, it is preferable that the metal oxide particle-containing layer 12 is laminated along the tapered shape (at the same inclination as the taper angle).

In the aspect shown in FIG. 3, the pressure sensitive adhesive layer 18 is laminated on one surface of the metal oxide particle-containing layer 12 that is opposite to the other surface thereof on which the transparent electrode pattern is formed.

<Material of Laminate>

[Transparent Base Material]

In the laminate according to the present disclosure, the transparent base material is preferably a glass substrate or a resin film base material having a refractive index of 1.50 to 1.55.

The transparent base material is composed of a light transmitting base material such as a glass base material. As the transparent base material, a cycloolefin polymer (COP) film base material, a polyethylene terephthalate (PET) base material, tempered glass, and the like can be used. Furthermore, as the transparent base material, the materials used in JP2010-086684A, JP2010-152809A, and JP2010-257492A can be preferably used, and the contents of these documents are incorporated into the present disclosure.

[Transparent Electrode Pattern]

The transparent electrode pattern preferably has a refractive index of 1.75 to 2.10. The material of the transparent electrode pattern is not particularly limited, and known materials can be used. For example, the transparent electrode pattern can be prepared using a light-transmitting conductive metal oxide film such as indium tin oxide (ITO), indium zinc oxide (IZO), or SiO₂, metals such as Al, Zn, Cu, Fe, Ni, Cr, and Mo, and the like. Among these, an ITO film having a refractive index of 1.75 to 2.10 is particularly preferable. The thickness thereof can be 10 to 200 nm. By baking, an amorphous ITO film turns into a polycrystalline ITO film. Therefore, in this way, electrical resistance can be reduced. Furthermore, the first transparent electrode pattern 3 which will be described later, the second transparent electrode pattern 4, and the conductive element 6 which will be described later can also be manufactured using conductive fiber. In addition, in a case where a first conductive pattern or the like is formed of ITO or the like, paragraphs “0014” to “0016” of JP4506785B can be referred to.

[Transparent Film]

The refractive index of the transparent film in the laminate according to the present disclosure is 1.60 to 1.78, and preferably 1.65 to 1.74. The transparent film may have a single-layer structure or a laminated structure consisting of two or more layers. In a case where the transparent film has a laminated structure consisting of two or more layers, the refractive index of the transparent film means the total refractive index of all layers.

The material of the transparent film is not particularly limited as long as the refractive index thereof satisfies the above range.

The preferred range of the material of the transparent film and the preferred range of physical properties of the transparent film such as a refractive index are the same as the preferred range of the materials of the metal oxide particle-containing layer and the preferred range of the physical properties of the metal oxide particle-containing layer.

From the viewpoint of optical homogeneity, it is preferable that the transparent film and the metal oxide particle-containing layer in the laminate according to the present disclosure are composed of the same material.

The transparent film in the laminate according to the present disclosure is preferably a transparent resin film. Metal oxide particles, a resin (binder), and other additives used in the transparent resin film are not particularly limited as long as these do not go against the object of the present disclosure. As the resin and other additives, the resin and other additives used in the metal oxide particle-containing layer in the transfer film according to the present disclosure can be preferably used.

The transparent film in the laminate according to the present disclosure may be an inorganic film. As the material used in the inorganic film, the material used in the metal oxide particle-containing layer in the transfer film according to the present disclosure can be preferably used.

In the laminate according to the present disclosure, one side of the pressure sensitive adhesive layer opposite to the other side thereof contacting the metal oxide particle-containing layer may be provided with nothing, provided with the aforementioned temporary support, or provided with an optical member such as a polarizing plate. For example, one side described above may be provided with a display panel in a display device such as a liquid crystal display device or an organic EL display device or provided with a protective member such as protective glass.

For instance, in the laminate illustrated in FIG. 2 or FIG. 3, the temporary support may be optionally peeled from one surface of the pressure sensitive adhesive layer 18 that is opposite to the other surface thereof contacting the metal oxide particle-containing layer 12, and then the aforementioned optical member or display panel may be attached to one surface described above such that a laminate having the optical member or the display panel is obtained.

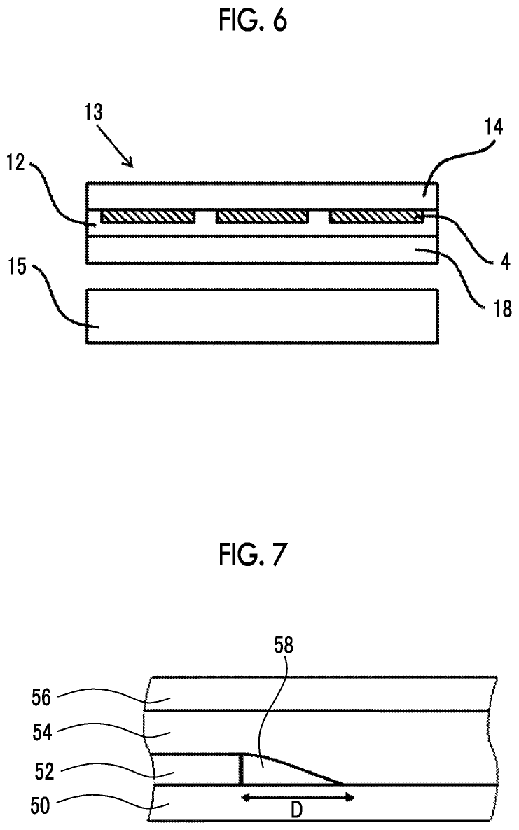

FIG. 6 shows another aspect (hereinafter, also referred to as “aspect B”) of the laminate according to the present disclosure.

FIG. 6 is a schematic cross-sectional view of an example of a laminate 13 according to the present disclosure.

In FIG. 6, the laminate 13 has the pressure sensitive adhesive layer 18, the metal oxide particle-containing layer 12, the transparent electrode pattern 4, and a transparent base material 14 in this order.

Examples of a display device 15 include a liquid crystal display device, an organic EL display device, and the like.

In a case where one surface of the pressure sensitive adhesive layer 18 in the laminate 13 that is opposite to the other surface thereof contacting the metal oxide particle-containing layer 12 is attached to the display device 15, a laminate including the display device 15 is obtained.

In this aspect, as the transparent base material 14, for example, a glass base material is used. Alternatively, a resin base material may be used as the transparent base material 14, and a glass member may be additionally attached to one surface of the resin base material that is opposite to the other surface thereof contacting the metal oxide particle-containing layer 12.

Furthermore, a laminate including the display device 15 can also be obtained by an aspect in which one surface of the transparent base material 14 in the laminate 13 that is opposite to the other surface thereof contacting the metal oxide particle-containing layer 12 is attached to the display device 15.

In this aspect, for example, a protective member such as cover glass is attached to one surface of the pressure sensitive adhesive layer 18 that is opposite to the other surface thereof contacting the metal oxide particle-containing layer 12.

In the present disclosure, examples of the protective member include glass, a resin, and the like. For example, a glass plate, a resin sheet, and the like are used.

Furthermore, an aspect may be adopted in which the transparent electrode pattern 4 is formed on both surfaces of the transparent base material 14 in the laminate 13, and the metal oxide particle-containing layer 12 and the pressure sensitive adhesive layer 18 are formed on the surface of both the transparent electrode patterns 4.

According to this aspect, for example, the pressure sensitive adhesive layer 18 on the surface of one transparent electrode pattern 4 can be attached to a protective member such as cover glass, and the pressure sensitive adhesive layer 18 on the surface of the other transparent electrode pattern 4 can be attached to the display device 15.

In a case where the pressure sensitive adhesive layers 18 are attached to the protective member and the display device as described above, a laminate is obtained which has the protective member, the pressure sensitive adhesive layer 18, the metal oxide particle-containing layer 12, the transparent electrode pattern 4, the transparent base material 14, the transparent electrode pattern 4, the metal oxide particle-containing layer 12, the pressure sensitive adhesive layer 18, and the display device 15 in this order.

The preferred ranges of the pressure sensitive adhesive layer 18 and the metal oxide particle-containing layer 12 in the aspect B are the same as the preferred ranges of the pressure sensitive adhesive layer and the metal oxide particle-containing layer in the transfer film according to the present disclosure.

In the aspect B, there may be the aforementioned transparent film (not shown in the drawing) between the transparent base material 14 and the transparent electrode pattern 4.

Furthermore, there may be an undercoat layer and an overcoat layer between the transparent electrode pattern 4 and the transparent base material 14. The coat layer may be formed of one layer or a plurality of layers. The coat layer may have a refractive index adjusting function. The refractive index of the coat layer is preferably equal to or lower than the refractive index of a conductive layer. The coat layer may have a gas barrier function or a rustproofing function.

The preferred aspect of the transparent electrode pattern 4 in the aspect B is the same as the preferred aspect of the transparent electrode pattern 4 in the aspect A.

In addition, the transparent electrode pattern 4 may further include metal nanowires or a metal mesh. The metal nanowires refer to a conductive substance which is made of a metal, is needlelike or threadlike in shape, and has a diameter on the order of nanometer. The metal nanowires may be linear or curved. In a case where a transparent conductive layer composed of metal nanowires is used, because the metal nanowires form meshes of a net, an excellent electrical conduction path can be formed with a small amount of metal nanowires, and a transparent conductive film with a low electrical resistance can be obtained. Furthermore, because the metal nanowires form meshes of a net, opening portions are formed in the voids of the meshes of the net, and thus a transparent conductive film having a high light transmittance can be obtained.

As the metal composing the metal nanowires, any appropriate metal can be used as long as it has high conductivity. Examples of the metal composing the metal nanowires include silver, gold, copper, nickel, and the like. Furthermore, materials obtained by performing a plating treatment (for example, a gold plating treatment) on these metals may also be used. Among these, from the viewpoint of conductivity, silver, copper, or gold is preferable, and silver is more preferable.

On the transparent base material 14, as a transparent conductive layer including metal mesh, thin metal wires form, for example, a lattice-like pattern. For the transparent conductive layer, it is possible to use the same metal as the metal composing the metal nanowires described above. The transparent conductive layer including metal mesh can be formed by any appropriate method. For example, by coating a base material laminate with a photosensitive composition containing a silver salt (a composition for forming a transparent conductive layer) and then performing an expose treatment and a development treatment so as to form the desired pattern of thin metal wires, the transparent conductive layer can be obtained.

The transparent base material 14 undergoes steps of forming a wiring pattern or a black matrix, performing a crystallization treatment, and the like. Therefore, it is preferable that the transparent base material 14 has excellent heat resistance and excellent chemical resistance. Examples of the material of the transparent base material 14 include glass, a resin substrate, and the like. The transparent base material 14 may be formed as a single layer or as a composite substrate including several members. The thickness of the transparent base material 14 is preferably 0.05 mm to 2.00 mm, more preferably 0.1 mm to 1.3 mm, and particularly preferably 0.2 mm to 1.1 mm. In a case where glass having a thickness equal to or smaller than 0.2 mm is used, a substrate having excellent flexibility can be obtained. However, in order to prevent the risk of crack development and break, it is preferable that the glass comprises a resin layer on one surface or both surfaces thereof. Furthermore, the resin base material may be partially or totally molded into a curved shape or a curved surface shape.

In a case where the transparent base material 14 is made of glass, it is preferable to select a glass plate having excellent strength and excellent light transmittance, such as soda-lime glass, alkali-free glass, borosilicate glass, and aluminosilicate glass. In a case where a glass plate having excellent strength is selected, the substrate can be thinned. Particularly, chemically strengthened glass (aluminosilicate or soda lime) is suitability used because it has excellent compressive strength.

As raw materials of the transparent resin base material, for example, it is possible to use polyester-based resins such as PET and polyethylene naphthalate (PEN), cycloolefin-based resins such as COP and a cycloolefin copolymer (COC), polyolefin-based resins such as polyethylene (PE), polypropylene (PP), polystyrene, and an ethylene-vinyl acetate copolymer (EVA), vinyl-based resins, polycarbonate-based resins, urethane-based resins, polyamide-based resins, polyimide-based resins, acrylic resins, epoxy-based resins, polyarylate-based resins, polysulfone-based resins, silsesquioxane-based resins, triacetyl cellulose (TAC), and the like. In order to avoid the occurrence of uneven coloring interference resulting from phase difference, it is preferable to use an optically isotropic base material. As optically isotropic resin materials, for example, cycloolefin-based resins, polycarbonate-based resins, and polyarylate-based resins are recommended.

The laminate according to the present disclosure may have a functional layer in a portion that corresponds to the outside (viewing side) of the transparent base material 14 in a case where the laminate is seen from the display device 15. Examples of the functional layer include a hard coat (HC) layer, an antireflection layer, an antifouling layer, an antistatic layer, a layer that has been treated for the purpose of diffusion or antiglare, and the like. These may be randomly combined such that a composite functional layer is formed. Furthermore, the cover member and the functional layer may be endowed with an ultraviolet absorbing function.

A protective film for preventing shattering may be laminated on either the outside or the inside of the transparent base material. The shatterproof film may have the functional layer described above. In order to avoid the occurrence of uneven coloring interference resulting from phase difference, it is preferable to use an optically isotropic base material (an unstretched cycloolefin polymer film or a polycarbonate film obtained by a casting method). Furthermore, a constitution may also be adopted in which a retardation plate (a λ/4 wavelength plate) for sunglasses is disposed at any position between the cover member and the image display device. It is preferable that the retardation plate (λ/4 wavelength plate) is disposed such that an angle of 45° is formed between the slow axis and the absorption axis of the polarizing plate on the viewing side of the image display device.

A decorative layer can be provided on the transparent base material 14. For example, the decorative layer is formed of a coloring ink containing a resin binder and a pigment or dye as a colorant. By a method such as screen printing, offset printing, or gravure printing, the decorative layer consisting of one layer or multiple layers is formed. The thickness of the layer formed by the above printing method is preferably about 0.5 to 50 μm. Furthermore, in order to express a color with metallic luster, a layer made of a thin metal film may be formed by a vapor deposition method or a sputtering method. The decorative layer may be formed on either of the surfaces of the cover member, or may be formed and laminated on a film such as the shatterproof film described above. In addition, the decorative layer may also be formed on the protective member.

(Method for Manufacturing Laminate)

The method for manufacturing a laminate according to the present disclosure includes a step of laminating the metal oxide particle-containing layer and the pressure sensitive adhesive layer in the transfer film according to the present disclosure on the transparent electrode pattern in this order.

In a case where the above constitution is adopted, the metal oxide particle-containing layer and the pressure sensitive adhesive layer of the laminate can be transferred at once. Therefore, a laminate in which the visibility of a transparent electrode pattern is reduced can be easily manufactured with excellent productivity.

In the method for manufacturing a laminate according to the present disclosure, the metal oxide particle-containing layer is formed on the transparent electrode pattern and the transparent film in the non-patterned region, directly or through another layer.

<Surface Treatment for Transparent Base Material>

Furthermore, in order to improve the adhesiveness between layers by the lamination in a transfer step to be performed later, a surface treatment can be performed in advance on a noncontact surface of the transparent base material (front plate). As the surface treatment, surface treatment using a silane compound (a silane coupling treatment) or a corona treatment can be performed.

<Formation of Transparent Electrode Pattern>

The transparent electrode pattern can be formed on the transparent base material or on the transparent film which has a refractive index of 1.60 to 1.78 and a film thickness equal to or greater than 30 nm and equal to or smaller than 300 nm by using the method of forming the first transparent electrode pattern 3, the second transparent electrode pattern 4, and another conductive element 6 in the description of the capacitive input device according to the present disclosure that will be described later. It is preferable to use a method using a photosensitive film.

<Formation of Pressure Sensitive Adhesive Layer and Metal Oxide Particle-Containing Layer>

The method of forming the pressure sensitive adhesive layer and the metal oxide particle-containing layer is, for example, a method having a protective film removing step of optionally removing the aforementioned protective film from the transfer film according to the present disclosure, a transfer step of transferring the pressure sensitive adhesive layer and the metal oxide particle-containing layer of the transfer film according to the present disclosure, from which the protective film has been removed, onto a transparent electrode pattern, an exposure step of optionally exposing the pressure sensitive adhesive layer and the metal oxide particle-containing layer transferred onto the transparent electrode pattern, and a development step of optionally developing the exposed pressure sensitive adhesive layer and metal oxide particle-containing layer.

[Transfer Step]

The transfer step is a step of transferring the pressure sensitive adhesive layer and the metal oxide particle-containing layer of the transfer film according to the present disclosure, from which the protective film has been removed, onto a transparent electrode pattern.

In this step, it is preferable to use a method including a step of laminating the pressure sensitive adhesive layer and the metal oxide particle-containing layer of the transfer film according to the present disclosure on the transparent electrode pattern and then removing the temporary support.

The pressure sensitive adhesive layer and the metal oxide particle-containing layer are transferred (bonded) to the surface of the base material by stacking, pressing, and heating the pressure sensitive adhesive layer and the metal oxide particle-containing layer on the surface of the transparent electrode pattern. For bonding, it is possible to use known laminators such as a laminator, a vacuum laminator, and an auto-cut laminator capable of further improving productivity.

[Exposure Step and Other Steps]

As the exposure step and other steps, for example, the methods described in paragraphs “0035” to “0051” in JP2006-023696A can be suitably used in the present disclosure.

The exposure step is a step of exposing the pressure sensitive adhesive layer and the metal oxide particle-containing layer transferred onto the transparent electrode pattern.

Herein, a light source for the exposure may be appropriately selected and used as long as it can radiate light in a wavelength range (for example, 365 nm, 405 nm, and the like) in which the pressure sensitive adhesive layer and the metal oxide particle-containing layer can be cured. Specific examples of the light source include an ultrahigh-pressure mercury lamp, a high-pressure mercury lamp, a metal halide lamp, and the like. The exposure amount is preferably about 5 mJ/cm² to 200 mJ/cm², and more preferably about 10 mJ/cm² to 100 mJ/cm².

The method for manufacturing a laminate may have other steps such as a post-exposure step and a post-baking step.

<Formation of Transparent Film>

In a case where the laminate according to the present disclosure further has a transparent film having a refractive index of 1.60 to 1.78 and a film thickness of 55 nm to 110 nm on one side of the transparent electrode pattern that is opposite to the other side thereof on which the metal oxide particle-containing layer is formed, the transparent film is formed on the transparent electrode pattern directly or through another layer such as a third transparent film.

Although the method of forming the transparent film is not particularly limited, it is preferable to form the transparent film by transfer or sputtering.

Particularly, in the laminate according to the present disclosure, the transparent film is preferably formed by transferring a transparent curable resin film formed on a temporary support onto the aforementioned transparent base material, and more preferably formed by curing the transparent curable resin film after transfer. For example, the transfer and curing can be performed by a method of performing transfer, exposure, development, and other steps just as the method of transferring the pressure sensitive adhesive layer and the metal oxide particle-containing layer in the method for manufacturing a laminate according to the present disclosure by using the photosensitive film having a photocurable resin layer described in paragraphs “0105” to “0138” of JP2014-158541A. In this case, it is preferable to disperse the metal oxide fine particles in the photocurable resin layer in the photosensitive film such that the refractive index of the transparent film is adjusted to the range described above.

In contrast, in a case where the transparent film is an inorganic film, the transparent film is preferably formed by sputtering. That is, in the laminate according to the present disclosure, it is also preferable that the transparent film is formed by sputtering.

As the sputtering method, the methods described in JP2010-086684A, JP2010-152809A, and JP2010-257492A can be preferably used, and the contents of these documents are incorporated into the present disclosure.

(Capacitive Input Device)

The capacitive input device according to the present disclosure is prepared using the transfer film according to the present disclosure, or includes the laminate according to the present disclosure.

It is preferable that the capacitive input device according to the present disclosure has a laminate having a transparent electrode pattern, a metal oxide particle-containing layer that is disposed adjacent to the transparent electrode pattern and contains metal oxide particles, and a pressure sensitive adhesive layer that is disposed adjacent to the metal oxide particle-containing layer, in which a variation of the content of the metal oxide particles is equal to or smaller than 10% in the film thickness direction.

Hereinafter, preferred aspects of the capacitive input device according to the present disclosure will be specifically described.

The capacitive input device according to the present disclosure has a front plate (corresponding to the transparent base material in the laminate according to the present disclosure) and at least the following elements (3) to (5), (7), and (8) on a noncontact side of the front plate. It is preferable that the capacitive input device has the laminate according to the present disclosure.

(3) A plurality of first transparent electrode patterns including a plurality of pad portions extending in one direction through connecting portions

(4) A plurality of second electrode patterns that are electrically insulated from the first transparent electrode patterns and include a plurality of pad portions extending in a direction intersecting with the first direction

(5) Insulating layer that electrically insulates the first transparent electrode patterns and the second electrode patterns from each other

(7) Metal oxide particle-containing layer formed to cover some or all of the elements (3) to (5)

(8) Pressure sensitive adhesive layer formed adjacent to the metal oxide particle-containing layer in (7)

Here, (7) metal oxide particle-containing layer corresponds to the metal oxide particle-containing layer in the laminate according to the present disclosure. Furthermore, (8) pressure sensitive adhesive layer corresponds to the pressure sensitive adhesive layer in the laminate according to the present disclosure.

As described above, in a case where a capacitive input device having a pressure sensitive adhesive layer is manufactured, it is easy to bond a polarizing film, a retardation film, cover glass, and various other optical members onto the pressure sensitive adhesive layer.

In the capacitive input device according to the present disclosure, (4) second electrode patterns may or may not be transparent electrode patterns, but are preferably transparent electrode patterns.

The capacitive input device according to the present disclosure may further have the element (6).

(6) Conductive element that is electrically connected to at least one of the first transparent electrode patterns or the second transparent electrode patterns and is different from the first transparent electrode patterns and the second transparent electrode patterns.

It is preferable that WVTR of a layer formed on the transparent electrode patterns in the capacitive input device according to the present disclosure is within the above range, because then the corrosion of the first or second transparent electrode patterns is inhibited, and particularly the effect of inhibiting the corrosion of the conductive element described above is exhibited.

In a case where (4) second electrode patterns are not transparent electrode patterns, and the capacitive input device does not have (6) another conductive element, (3) first transparent electrode patterns correspond to the transparent electrode pattern in the laminate according to the present disclosure.

In a case where (4) second electrode patterns are transparent electrode patterns, and the capacitive input device does not have (6) another conductive element, at least either (3) first transparent electrode patterns or (4) second electrode patterns correspond to the transparent electrode pattern in the laminate according to the present disclosure.

In a case where (4) second electrode patterns are not transparent electrode patterns, and the capacitive input device has (6) another conductive element, at least either (3) first transparent electrode patterns or (6) another conductive element corresponds to the transparent electrode pattern in the laminate according to the present disclosure.

In a case where (4) second electrode patterns are transparent electrode patterns, and the capacitive input device has (6) another conductive element, at least one of (3) first transparent electrode patterns, (4) second electrode patterns, and (6) another conductive element corresponds to the transparent electrode pattern in the laminate according to the present disclosure.

It is preferable that the capacitive input device according to the present disclosure further has (2) transparent film between (3) first transparent electrode patterns and the front plate, between (4) second transparent electrode patterns and the front plate, or between (6) another conductive element and the front plate. From the viewpoint of further improving the visibility of the transparent electrode pattern, (2) transparent film preferably corresponds to the transparent film that is included in the laminate according to the present disclosure and has a refractive index of 1.60 to 1.78 and a film thickness equal to or greater than 30 nm and equal to or smaller than 300 nm.

It is preferable that the capacitive input device according to the present disclosure optionally further has (1) mask layer and/or decorative layer. The mask layer is provided as a black frame around a region to be touched with a finger or a stylus so as to prevent the routing wiring of the transparent electrode pattern from being seen from the contact side or to decorate the device. The decorative layer is provided for decoration. For example, it is preferable that a white decorative layer is provided.

It is preferable that the capacitive input device has (1) mask layer and/or decorative layer between (2) transparent film and the front plate, between (3) first transparent electrode patterns and the front plate, between (4) second transparent electrode patterns and the front plate, or between (6) another conductive element and the front plate. (1) Mask layer and/or decorative layer are (is) more preferably disposed adjacent to the front plate.

Even though the capacitive input device according to the present disclosure includes various members described above, the visibility of the transparent electrode pattern can be reduced by the metal oxide particle-containing layer disposed adjacent to the transparent electrode pattern and the pressure sensitive adhesive layer disposed adjacent to the metal oxide particle-containing layer that are included in the capacitive input device. Furthermore, as described above, in a case where a constitution is adopted in which the transparent electrode pattern is interposed between the metal oxide particle-containing layer and the transparent film that has a refractive index of 1.60 to 1.78 and a film thickness equal to or greater than 30 nm and equal to or smaller than 300 nm, the problem of visibility of the transparent electrode pattern can be further improved.

<Constitution of Capacitive Input Device>

First, a preferred constitution of the capacitive input device according to the present disclosure will be described together with a method for manufacturing each member composing the device. FIG. 2 is a cross-sectional view showing a preferred constitution of the capacitive input device according to the present disclosure. In the aspect shown in FIG. 2, a capacitive input device 10 is composed of a transparent base material (front plate) 1, a mask layer 2, a transparent film 11 that has a refractive index of 1.60 to 1.78 and a film thickness equal to or greater than 30 nm and equal to or smaller than 300 nm, a first transparent electrode pattern 3, a second transparent electrode pattern 4, an insulating layer 5, a conductive element 6, a metal oxide particle-containing layer 12, and a pressure sensitive adhesive layer 18.

The conductive element 6 can be prepared using a metal such as Al, Zn, Cu, Fe, Ni, Cr, or Mo. From the viewpoint of conductivity, the conductive element 6 is most preferably copper.

FIG. 3 that is a cross-sectional view taken along X1-X2 in FIG. 5 which will be described later is also a cross-sectional view showing a preferred constitution of the capacitive input device according to the present disclosure. In the aspect shown in FIG. 3, the capacitive input device 10 is composed of a transparent base material (front plate) 1, a transparent film 11 that has a refractive index of 1.60 to 1.78 and a film thickness of 55 nm to 110 nm, a first transparent electrode pattern 3, a second transparent electrode pattern 4, a metal oxide particle-containing layer 12, and a pressure sensitive adhesive layer 18.

As the transparent base material (front plate) 1, it is possible to use those exemplified above as materials of the transparent electrode pattern in the laminate according to the present disclosure. In addition, in FIG. 2, a side of the front plate 1 on which each element is provided is referred to as noncontact surface. A user inputs data to the capacitive input device 10 according to the present disclosure by touching a contact surface (a surface opposite to the noncontact surface) of the front plate 1 with a finger or the like.

The mask layer 2 is provided on the noncontact surface of the front plate 1. The mask layer 2 is a frame-shaped pattern around a display area formed on a noncontact side of a front plate of a touch panel, and is formed to make routing wiring invisible.

A plurality of first transparent electrode patterns 3 that include a plurality of pad portions extending in a first direction through connecting portions, a plurality of second transparent electrode patterns 4 that are electrically insulated from the first transparent electrode patterns 3 and include a plurality of pad portions extending in a direction intersecting with the first direction, and the insulating layer 5 that electrically insulates the first transparent electrode patterns 3 and the second transparent electrode patterns 4 from each other are formed on the contact surface of the front plate 1. As the first transparent electrode patterns 3, the second transparent electrode patterns 4, and the conductive element 6 which will be described later, it is possible to use those exemplified above as the material of the transparent electrode pattern in the laminate according to the present disclosure.

At least one of the first transparent electrode patterns 3 or the second transparent electrode patterns 4 can be installed in a region including both the noncontact surface of the front plate 1 and one surface of the mask layer 2 that is opposite to the other surface thereof contacting the front plate 1. In FIG. 2, the second transparent electrode pattern is installed in a region including both the noncontact surface of the front plate 1 and one surface of the mask layer 2 that is opposite to the other surface thereof adjacent to the front plate 1. In laminating a photosensitive film covering both the mask layer that needs to have a certain thickness and the back surface of the front plate as described above, in a case where a photosensitive film having a specific layer constitution that will be described later is used, even though an expensive facility such as a vacuum laminator is not used, it is possible to laminate the photosensitive film through a simple process without causing bubbles at the boundary of the mask portion.

The first transparent electrode patterns 3 and the second transparent electrode patterns 4 will be described using FIG. 5. FIG. 5 is a view illustrating an example of the first transparent electrode pattern and the second transparent electrode pattern in the present disclosure. As shown in FIG. 5, the first transparent electrode patterns 3 include the pad portions 3a extending in a first direction LY through connecting portions 3b. Furthermore, the second transparent electrode patterns 4 are electrically insulated from the first transparent electrode patterns 3 by the insulating layer 5 and composed of a plurality of pad portions extending in a direction (a second direction LX in FIG. 5) intersecting with the first direction LY. In a case where the first transparent electrode patterns 3 are formed, the pad portions 3a and the connecting portions 3b may be prepared as one unit. Alternatively, the connecting portions 3b may be separately prepared, and then the pad portions 3a and the second transparent electrode patterns 4 may be prepared (patterned) as one unit. In a case where the pad portions 3a and the second transparent electrode patterns 4 are prepared (patterned) as one unit, each layer is formed such that a portion of each of the connecting portions 3b is connected to a portion of each of the pad portions 3a, and the first transparent electrode patterns 3 and the second transparent electrode patterns 4 are electrically insulated from each other by the insulating layer 5 as shown in FIG. 5.

In addition, in FIG. 5, the region in which the first transparent electrode patterns 3, the second transparent electrode patterns 4, or the conductive element 6 which will be described later is not formed corresponds to the non-patterned region 22 in the laminate according to the present disclosure.

In FIG. 2, the conductive element 6 is installed on one side of the mask layer 2 that is opposite to the other side thereof contacting the front plate 1. The conductive element 6 is an element which is electrically connected to at least one of the first transparent electrode patterns 3 or the second transparent electrode patterns 4, and different from the first transparent electrode patterns 3 and the second transparent electrode patterns 4.

Furthermore, in FIG. 2, the pressure sensitive adhesive layer 18 is installed to cover all the constituents. The pressure sensitive adhesive layer 18 may be composed to cover only some of the constituents. The insulating layer 5 and the pressure sensitive adhesive layer 18 may be made of the same material or different materials. As the material composing the insulating layer 5, those exemplified above as the material of the pressure sensitive adhesive layer or metal oxide particle-containing layer in the laminate according to the present disclosure can be preferably used.

<Method for Manufacturing Capacitive Input Device>

Examples of aspects formed in the process of manufacturing the capacitive input device according to the present disclosure include the aspects shown in FIG. 3 to FIG. 7 of JP2014-158541A.

In the method for manufacturing a capacitive input device, the metal oxide particle-containing layer 12 and the pressure sensitive adhesive layer 18 can be formed using the transfer film according to the present disclosure by transferring the metal oxide particle-containing layer and the pressure sensitive adhesive layer to the surface of the front plate 1 on which each element is arbitrarily formed.

In the method for manufacturing a capacitive input device, at least one of the elements consisting of the mask layer 2, the first transparent electrode patterns 3, the second transparent electrode patterns 4, the insulating layer 5, and the conductive element 6 may be formed using the photosensitive film described in paragraphs “0105” to “0138” of JP2014-158541A that has a temporary support and a photocurable resin layer in this order.

In a case where each of the above elements is formed using the transfer film according to the present disclosure or the aforementioned photosensitive film, even though the base material (front plate) has opening portions, resist components do not leak or hardly leak from the opening portions. Particularly, resist components do not leak from the end of glass in a mask layer on which a light shielding pattern needs to be formed substantially to the boundary of the front plate. Therefore, the contamination of the back surface of the base material is inhibited, and a lightweight touch panel in the form of a thin layer can be manufactured through a simple process.

In a case where the mask layer, the insulating layer, and the conductive photocurable resin layer described above are used, and permanent materials such as the first transparent electrode pattern, the second transparent electrode pattern, and the conductive element are formed using the photosensitive film described above, by laminating the photosensitive film on a base material, then optionally exposing the photosensitive film patternwise, and removing an unexposed portion in a case where the metal oxide particle-containing layer is a negative material or removing an exposed portion in a case where the metal oxide particle-containing layer is a positive material by a development treatment, the patterns can be obtained. In the development, a thermoplastic resin layer and a photocurable resin layer may be developed and removed using different liquids or may be removed using the same liquid. Known development facilities such as a brush and a high pressure jet may be optionally combined. After development, post-exposure and post-baking may be optionally performed.

(Image Display Device)

The image display device according to the present disclosure comprises the capacitive input device according to the present disclosure.

The constitution disclosed in “The Latest Touch Panel Technologies” (published on Jul. 6, 2009, Techno-Times Co., Ltd.), “Technologies and Development of Touch Panel” (supervised by Yuji Mitani, CMC Publishing CO., LTD., 2004, 12), T-11 lecture textbook of FPD International 2009 Forum, Cypress Semiconductor Corporation Application Note AN2292, and the like can be applied to the capacitive input device according to the present disclosure and the image display device that the capacitive input device comprises as a constituent.

### EXAMPLES

Hereinafter, the present invention will be more specifically described using examples. The materials, amount of materials used, ratio of materials, details of treatments, procedures of treatments, and the like shown in the following examples can be appropriately changed unless such changes defeat the object of the present invention. Therefore, the scope of the present invention is not limited to the specific examples described below. In addition, unless otherwise specified, “part” and “%” are based on mass.

### Examples 1 to 11 and Comparative Examples 1 to 3

<Preparation of Transfer Film>

[Preparation of Composition for Forming Pressure Sensitive Adhesive Layer]

By mixing together components according to the composition described in the following Table 3 or Table 4, coating solutions A-1, A-2, and C-1 to C-3 for forming a pressure sensitive adhesive layer were prepared. The numerical values in each table represent the amount (part by mass) of each of the components used.

TABLE 3

| | Material | A-1 | A-2 |
|---|---|---|---|
| Polymerizable | Tricyclodecane dimethanol diacrylate | 5.60 | 7.14 |
| monomer | (manufactured by A-DCP Shin-Nakamura Chemical Co., Ltd) | | |
| | Carboxylic acid-containing monomer ARONIX TO-2349 | 0.93 | 0.93 |
| | (manufactured by TOAGOSEI CO., LTD.) | | |
| | Urethane acrylate 8UX-015A | 2.80 | 2.80 |
| | (manufactured by TAISEI FINE CHEMICAL CO,. LTD.) | | |
| Anticorrosive | Benzimidazole (Tokyo Chemical Industry Co., Ltd.) | 0.09 | 0.09 |
| Resin | The following compound D (Acid value: 95 mgKOH/g) | 15.44 | 13.90 |
| Polymerization | Phenothiazine (manufactured by Seiko Chemical Co., Ltd.) | 0.01 | 0.01 |
| inhibitor | | | |
| Additive | Duranate X3071.04 (manufactured by Asahi Kasei Chemicals | 4.83 | 4.83 |
| | Corporation) | | |
| Surfactant | Megaface F551 (manufactured by DIC Corporation) | 0.16 | 0.16 |
| Solvent | Methyl ethyl ketone | 40.00 | 40.00 |
| | 1-Methoxy-2-propyl acetate | 29.80 | 29.80 |

In Table 3, a compound D is a resin having the following structure. The subscripts in parentheses indicating constitutional units represent the content ratio (mass ratio) of each of the constitutional units.

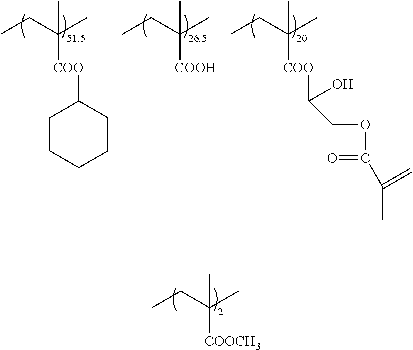

TABLE 4

| | Material | C-1 | C-2 | C-3 |
|---|---|---|---|---|
| Polymerizable | EHA (manufactured by Wako Pure Chemical Industries, | 5.0 | 5.0 | 5.0 |
| monomer | Ltd.) | | | |
| | IBXA (manufactured by OSAKA ORGANIC | 18.0 | 18.0 | 18.0 |
| | CHEMICAL INDUSTRY LTD.) | | | |
| Adhesion improver | CYCLOMER M100 (manufactured by DAICEL | 2.0 | 2.0 | 2.0 |
| | Corporation) | | | |
| Crosslinkable rubber | UC-102 (manufactured by KURARAY CO., LTD.) | 21.8 | 41.2 | 17.9 |
| Tackifier | UH115 (manufactured by YASUHARA CHEMICAL | 38.8 | 19.4 | 46.6 |
| (viscosity imparting | CO., LTD.) | | | |
| agent) | | | | |
| Noncrosslinked rubber | Polyvest110 (manufactured by Evonik Japan Co., Ltd.) | 8.8 | 8.8 | 4.9 |
| Chain transfer agent | DDT (manufactured by Tokyo Chemical Industry Co., | 2.6 | 2.6 | 2.6 |
| | Ltd.) | | | |
| Photopolymerization | TPO (manufactured by BASF SE) | 3.0 | 3.0 | 3.0 |
| initiator | | | | |

Details of each component described using abbreviations in Table 4 are as follows.

[Polymerizable Monomer]
EHA (2-ethylhexyl acrylate, manufactured by Wako Pure Chemical Industries, Ltd., SP value: 7.8)
IBXA (isobornyl acrylate, manufactured by OSAKA ORGANIC CHEMICAL INDUSTRY LTD., SP value: 8.4)

[Adhesion Improver]
CYCLOMER M-100 (trade name, manufactured by Daicel Corporation, 3,4-epoxycyclohexylmethyl methacrylate)

[Rubber]
KURAPRENE UC-102M (trade name, manufactured by KURARAY CO., LTD., methacrylate-modified polyisoprene, weight-average molecular weight: 17,000, SP value: 8.0)
Polyvest 110 (trade name, manufactured by Evonik Industries AG, unmodified liquid polybutadiene, weight-average molecular weight: 2,600, SP value: 8.3)

[Viscosity Imparting Agent]
UH-115 (trade name, manufactured by YASUHARA CHEMICAL CO., LTD., hydrogenated terpene phenol resin)

[Chain Transfer Agent]
DDT (trade name, dodecanethiol, manufactured by TOKYO CHEMICAL INDUSTRY CO., LTD.)

[Photopolymerization Initiator]
Lucirin TPO (trade name, manufactured by BASF SE, 2,4,6-trimethylbenzoyl-diphenylphosphine oxide)

[Preparation of Composition for Forming Metal Oxide Particle-Containing Layer]

Components were mixed together according to the compositions described in the following Table 5, thereby preparing compositions B-1 to B-5 for forming a metal oxide particle-containing layer and a comparative composition B′-1. The numerical values in each table represent the amount (part by mass) of each of the components used.

TABLE 5

| Material | B-1 | B-2 | B-3 | B-4 | B-5 | B′-1 |
|---|---|---|---|---|---|---|
| Nano Use OZ-S30M:ZrO₂ particles, methanol dispersion | 3.88 | 3.88 | 3.88 | 3.88 | 3.88 | 3.88 |
| (non-volatile components: 30.5%), manufactured by | | | | | | |
| NISSAN CHEMICAL INDUSTRIES, LTD. | | | | | | |
| Monoisopropylamine (manufactured by Mitsui Chemicals, | 0.22 | 0.22 | 0.22 | 0.22 | 0.22 | |
| Inc.) | | | | | | |
| Methacrylic acid/allyl methacrylate copolymer resin | 0.32 | 0.23 | 0.23 | 0.14 | | |
| (weight-average molecular weight: 38,000, compositional | | | | | | |
| ratio = 40/60) | | | | | | |
| Actflow CB-3098 | | | | | 0.23 | |
| (weight-average molecular weight: 3,000, acid value: | | | | | | |
| 98.4 mgKOH/g, manufactured by Soken Chemical & | | | | | | |
| Engineering Co., Ltd.) | | | | | | |
| ARUFON UC-3920 | 0.05 | 0.05 | 0.05 | 0.05 | 0.05 | |
| (manufactured by TOAGOSEI CO., LTD.) | | | | | | |
| Carboxylic acid-containing monomer ARONIX TO- | 0.03 | 0.03 | 0.03 | 0.03 | 0.03 | |
| 2349 (manufactured by TOAGOSEI CO., LTD.) | | | | | | |
| Benzotriazole BT-LX (manufactured by JOHOKU | 0.03 | 0.03 | 0.03 | 0.03 | 0.03 | |
| CHEMICAL CO., LTD) | | | | | | |
| Megaface F444 (manufactured by DIC Corporation) | 0.01 | 0.01 | 0.01 | 0.01 | 0.01 | |
| Deionized water | 29.50 | 29.50 | 29.50 | 29.50 | | |
| Methanol | 66.00 | 66.00 | 66.00 | 66.00 | | 96.07 |
| Isopropyl alcohol | | | | | 95.59 | |
| Phthalic acid | | 0.04 | | 0.08 | | 00.3 |
| LIGHT-ESTER P-2M | | | 0.04 | | | |
| Total (part by mass) | 100 | 100 | 100 | 100 | 100 | 100 |

[Preparation of Transfer Film]

In each of the examples or comparative examples, by using a slit-shaped nozzle, a temporary support (Cerapeel 25WZ, manufactured by TORAY INDUSTRIES, INC., 25 μm) was coated with any one of the compositions A-1, A-2, and C-1 to C-3 for forming a pressure sensitive adhesive layer after the amount of the composition to be applied was adjusted to obtain a film thickness of 75.0 μm after drying. Then, the applied composition was dried for 2 minutes at 120° C.

Thereafter, in the examples in which the temporary supports were coated with the compositions C-1 to C-3 for forming a pressure sensitive adhesive layer, each of the applied compositions for forming a pressure sensitive adhesive layer was covered with a peelable film and irradiated with ultraviolet rays from a metal halide lamp for 3 minutes (exposure amount: 400 mJ/cm²), thereby forming a pressure sensitive adhesive layer.

In the example in which any one of the compositions A-1 and A-2 for forming a pressure sensitive adhesive layer was used, the applied composition was used as a pressure sensitive adhesive layer without being subjected to exposure.

Subsequently, a metal oxide particle-containing layer was formed as follows.

In Examples 1 to 8, 10, and 11, by using a slit-shaped nozzle, the pressure sensitive adhesive layer was coated with each of the compositions for forming a metal oxide particle-containing layer described in the following Table 6 after the amount of the composition to be applied was adjusted to obtain a film thickness of about 70 nm after drying. In Example 9, by using a slit-shaped nozzle, the pressure sensitive adhesive layer was coated such that the film thickness became 40 nm.

In the comparative examples, by using a slit-shaped nozzle, the pressure sensitive adhesive layer was coated with B′-1 applied in the same amount as the composition B-1 for forming a metal oxide particle-containing layer in Example 1.

Then, the applied composition was dried at 120° C. for 2 minutes, thereby forming a metal oxide particle-containing layer. A protective film (a polypropylene film having a thickness of 12 μm) was bonded onto the metal oxide particle-containing layer under pressure, thereby preparing transfer films of Examples 1 to 11 and Comparative Examples 1 to 3.

<Measurement of Refractive Index, Variation, Tan δ, Elongation at Break, Viscosity, and WVTR>

By using the transfer films obtained in the examples and comparative examples, the refractive index of the metal oxide particle-containing layer, the variation of the content of metal oxide particles in the metal oxide particle-containing layer in the film thickness direction, tan δ of the pressure sensitive adhesive layer at 23° C., the elongation at break of the pressure sensitive adhesive layer at 23° C., the viscosity of the pressure sensitive adhesive layer at 23° C., and WVTR of the transfer film at 60° C. were measured by the methods described above. The results are described in Table 6.

<Evaluation of Crack>

The transfer films obtained in the examples or comparative examples were observed (400× magnification) using a surface scanning electron microscope (SEM), and whether or not the metal oxide particle-containing layer cracked was checked.

The evaluation results are described in Table 6. In a case where a crack was checked, the example was marked as “Present”. In a case where no crack was checked, the example was marked as “Absent”. In Example 4, few cracks were observed which are unproblematic for practical use.

<Evaluation of WVTR>

By using the transfer films obtained in the examples and comparative examples, WVTR was measured by the method described above. The measurement results are described in Table 6.

<Evaluation of Step Conformability>

The transfer film obtained in each of the examples and comparative examples was cut in 3.0 cm×4.0 cm, the protective film was peeled off, the metal oxide particle-containing layer was bonded to a glass base material to which a 25 μm-thick polyimide tape (Kapton (registered trademark) tape, manufactured by DuPont-Toray Co., Ltd.) was bonded in advance, and these were laminated at 23° C., a transfer speed of 6 m/min, and a pressure of 0.7 kg/cm², thereby forming a laminate for evaluation.

For the prepared laminate for evaluation, the step around the Kapton tape was observed with an optical microscope manufactured by Nikon Corporation, and a boundary void width was measured.

More specifically, as shown in FIG. 7, the obtained sample was composed of a PET base material 50 bonded to a Kapton tape 52, and a metal oxide particle-containing layer, a pressure sensitive adhesive layer 54, and a temporary support 56 which are disposed on the PET base material 50.

As shown in FIG. 7, in the step portion of the Kapton tape 52, a void 58 is easily formed between the PET base material 50 and the metal oxide particle-containing layer as well as the pressure sensitive adhesive layer 54. The boundary void width means a distance D on the glass base material on which the Kapton tape 52 does not contact the metal oxide particle-containing layer and the pressure sensitive adhesive layer 54.

It can be said that the shorter the distance D is, the better the step conformability is. The step conformability evaluated as A or B is preferable. The step conformability was evaluated based on the following evaluation standard. The evaluation results are described in Table 6.

—Evaluation Standard—

A: The boundary void width (distance D) was less than 200

B: The boundary void width (distance D) was equal to or greater than 200 μm and less than 1,000

C: The boundary void width (distance D) was equal to or greater than 1,000

<Evaluation of Copper Corrosion Inhibition Properties>

A laminate for evaluation was prepared by the same method as the method used for evaluating step conformability, except that the Kapton tape was changed to a copper film (thickness: 6 μm). The laminate was left to stand for 300 hours in an environment of 85° C. and 85% RH.

Then, the surface of the copper film under the pressure sensitive adhesive layer and the metal oxide particle-containing layer was observed using an optical microscope (magnification: 50×), and the discoloration of copper was evaluated based on the following evaluation standard. The evaluation results are described in Table 6. The copper corrosion inhibition properties evaluated as A, B, or C are preferable. It can be said that the lower the proportion of the discolored portion is, the further the corrosion of the copper film is inhibited.

—Evaluation Standard—

A: No discolored portion was checked.

B: The proportion of the discolored portion was equal to or lower than 10% of the surface of the copper film.

C: The proportion of the discolored portion was higher than 10% of the surface of the copper film and equal to or lower than 50% of the surface of the copper film.

D: The proportion of the discolored portion was higher than 50% of the surface of the copper film.

<Visibility Reduction Evaluation>

A glass base material was prepared which had a transparent film on one surface and a transparent electrode pattern formed on the other surface.

The transfer film obtained in each of the examples and comparative examples was cut in 3.0 cm×4.0 cm, the protective film was peeled off, the metal oxide particle-containing layer was bonded to the transparent electrode pattern of the glass base material and laminated at 23° C., a transfer speed of 6 m/min, and a pressure of 0.7 kg/cm², thereby forming a laminate for evaluation.

A black PET material was bonded to the transparent film of the laminate by using a transparent adhesive tape (manufactured by 3M Company, trade name: OCA tape 8171CL).

After the laminate for evaluation was shielded from light as described above, the side of the laminate to which the transfer film was bonded was observed from various angles while being irradiated with light by using Gentos LED light (flashlight, brightness: 200 lumens, trade name: Flash 335 SG-335). The step conformability was evaluated based on the following evaluation standard. The evaluation results are described in the column of “Visibility” in Table 6. The step conformability evaluated as A or B is preferable.

—Evaluation Standard—

A: The transparent electrode pattern substantially was not seen from any angle.

B: At a certain angle, the transparent electrode pattern was slightly seen by the reflected light of the LED light.

C: At a certain angle, the transparent electrode pattern glittered by the reflected light of the LED light.

D: The transparent electrode pattern glittered at all angles by the reflected light of the LED light.

TABLE 6

| | | | | Characteristics of metal oxide | | | | | |
|---|---|---|---|---|---|---|---|---|---|
| | | | | particle-containing layer | | | | | |
| | | Composition | Composition | | Total content | | | | Characteristics of |
| | | for forming | for forming | | of specific | | | | pressure sensitive |
| | | pressure | metal oxide | Specific | compound A | | | | adhesive layer |
| | | sensitive | particle- | compound A, | and specific | Film | | | Film |
| | | adhesive | containing | Specific | compound B | thickness | Refractive | | thickness |
| | | layer | layer | compound B | (% by mass) | nm | index | Variation | μm |
| Example | 1 | C-1 | B-2 | Specific | 2.2 | 70 | 1.69 | Equal to | 75 |
| | | | | compound A | | | | or smaller | |
| | | | | | | | | than 10% | |
| | 2 | A-1 | B-2 | Specific | 2.2 | 70 | 1.69 | Equal to | 75 |
| | | | | compound A | | | | or smaller | |
| | | | | | | | | than 10% | |
| | 3 | C-2 | B-2 | Specific | 2.2 | 70 | 1.69 | Equal to | 75 |
| | | | | compound A | | | | or smaller | |
| | | | | | | | | than 10% | |
| | 4 | C-1 | B-1 | — | 0.0 | 70 | 1.69 | Equal to | 75 |
| | | | | | | | | or smaller | |
| | | | | | | | | than 10% | |
| | 5 | C-3 | B-2 | Specific | 2.2 | 70 | 1.69 | Equal to | 75 |
| | | | | compound A | | | | or smaller | |
| | | | | | | | | than 10% | |
| | 6 | A-2 | B-2 | Specific | 2.2 | 70 | 1.69 | Equal to | 75 |
| | | | | compound A | | | | or smaller | |
| | | | | | | | | than 10% | |
| | 7 | C-1 | B-3 | Specific | 2.2 | 70 | 1.69 | Equal to | 75 |
| | | | | compound A | | | | or smaller | |
| | | | | | | | | than 10% | |
| | 8 | C-1 | B-2 | Specific | 2.2 | 70 | 1.69 | Equal to | 10 |
| | | | | compound A | | | | or smaller | |
| | | | | | | | | than 10% | |
| | 9 | C-1 | B-2 | Specific | 2.2 | 40 | 1.69 | Equal to | 75 |
| | | | | compound A | | | | or smaller | |
| | | | | | | | | than 10% | |
| | 10 | C-1 | B-4 | Specific | 4.6 | 70 | 1.69 | Equal to | 75 |
| | | | | compound A | | | | or smaller | |
| | | | | | | | | than 10% | |
| | 11 | C-1 | B-5 | Specific | 13.1 | 70 | 1.69 | Equal to | 75 |
| | | | | compound B | | | | or smaller | |
| | | | | | | | | than 10% | |
| Comparative | 1 | A-2 | B′-1 | Specific | 2.5 | 140 | 1.69 | 40% | 75 |
| Example | | | | compound A | | | | | |
| | 2 | C-1 | B′-1 | Specific | 2.5 | 300 | 1.54 | 90% | 75 |
| | | | | compound A | | | | | |
| | 3 | A-1 | B′-1 | Specific | 2.5 | 100 | 1.69 | 30% | 75 |
| | | | | compound A | | | | | |

| | | Characteristics of pressure | | | | Evaluation | | | | |
|---|---|---|---|---|---|---|---|---|---|---|
| | | sensitive adhesive layer | | | | | Step conformability | | | |
| | | Tan | Elongation | Viscosity | WVTR | | Boundary void | | | Copper |
| | | δ | % | Pa · s | g/(m² · day) | Crack | width distance D | Evaluation | Visibility | corrosion |
| Example | 1 | 2.00 | 800 | 4.4 × 10⁴ | 254 | Absent | 0 | A | A | A |
| | 2 | 1.30 | 900 | 1.4 × 10⁶ | 533 | Absent | 250 | B | A | B |
| | 3 | 0.23 | 600 | 5.7 × 10⁴ | 2400 | Absent | 530 | B | A | C |
| | 4 | 2.00 | 800 | 4.4 × 10⁴ | 254 | Present | 0 | A | B | A |
| | 5 | 1.50 | 500 | 5.0 × 10⁵ | 450 | Absent | 300 | B | A | B |
| | 6 | 3.60 | 900 | 5.0 × 10⁴ | 400 | Absent | 0 | A | A | A |
| | 7 | 2.00 | 800 | 4.4 × 10⁴ | 254 | Absent | 0 | A | A | A |
| | 8 | 2.00 | 800 | 4.4 × 10⁴ | 1905 | Absent | 0 | A | A | C |
| | 9 | 2.00 | 800 | 4.4 × 10⁴ | 254 | Absent | 0 | A | B | A |
| | 10 | 2.00 | 800 | 4.4 × 10⁴ | 254 | Absent | 0 | A | A | A |
| | 11 | 2.00 | 800 | 4.4 × 10⁴ | 254 | Absent | 0 | A | A | A |
| Comparative | 1 | 3.60 | 900 | 5.0 × 10⁴ | 450 | Absent | 0 | A | C | B |
| Example | 2 | 1.90 | 800 | 6.0 × 10⁴ | 350 | Absent | 0 | A | D | A |
| | 3 | 1.30 | 900 | 1.4 × 10⁶ | 533 | Absent | 250 | B | C | B |

As is evident from the results described in Table 6, in a case where the transfer film according to the present disclosure is used, it is possible to form a metal oxide particle-containing layer and a pressure sensitive adhesive layer in this order, to provide a transfer film in which the visibility of a transparent electrode pattern is excellently reduced, and to provide a method for manufacturing a laminate using the transfer film.

In addition, from the results described in Table 6, it has been revealed that in a case where the transfer film according to the present disclosure is used, it is easy to obtain a laminate which is inhibited from experiencing cracking, has excellent step conformability, and inhibits the corrosion of copper.

Particularly, it has been revealed that in a case where the metal oxide particle-containing layer contains the specific compound A, the occurrence of cracks is markedly inhibited.

Furthermore, it has been revealed that in a case where the pressure sensitive adhesive layer has a tan δ equal to or higher than 1.5 at 23° C., an elongation at break equal to or higher than 600% at 23° C., and a viscosity equal to or lower than 1.0×10⁶ Pa·s at 23° C., the step conformability is markedly reduced.

In addition, it has been revealed that in a case where WVTR is equal to or lower than 1,100 g/(m²·day), the corrosion of copper is markedly inhibited. Moreover, from the results of Examples 1 and 7, it has been revealed that the corrosion of copper is easily inhibited in a case where the metal oxide particle-containing layer contains a compound that has a carboxy group, does not have an ethylenically unsaturated group, and a molecular weight less than 2,000 as the specific compound A and in a case where the metal oxide particle-containing layer contains a compound that has a phosphoric acid group and a molecular weight less than 2,000 as the specific compound A.

(Preparation of Capacitive Input Device)

By the method described in paragraphs “0167” to “0191” of JP2014-108541A, a front plate was obtained on which a mask layer, a transparent film, a first transparent electrode pattern, an insulating layer pattern, a second transparent electrode pattern, and a conductive element different from the first and second transparent electrode patterns were formed.

The transfer film obtained in each of the examples and comparative examples was laminated on the front plate under the same conditions as those adopted in the evaluation of visibility described above, thereby forming a metal oxide particle-containing layer and a pressure sensitive adhesive layer in this order from the front plate side.

(Preparation of Image Display Device)

The front plate on which the metal oxide particle-containing layer and the pressure sensitive adhesive layer were formed in each of the examples and comparative examples was bonded to a liquid crystal display device manufactured by the method described in JP2009-047936A, and image display devices of Examples 101 to 108 and Comparative Examples 101 to 103 each having a capacitive input device as a constituent were prepared by a known method.

### EVALUATION

The image display device in each of the examples was observed from various angles in a state where light was being radiated to the screen side by using Gentos LED light (flashlight, brightness: 200 lumens, trade name: Flash 335 SG-335) in the same manner as in evaluation of visibility described above.

The visibility was evaluated based on the same evaluation standard as the evaluation standard used for the evaluation of visibility described above.

The evaluation results were the same as the evaluation results obtained in a case where the visibility was evaluated using the transfer film in each of the examples and comparative examples.

### EXPLANATION OF REFERENCES

1: transparent base material (front plate)
2: mask layer
3: transparent electrode pattern (first transparent electrode pattern)
3a: pad portion
3b: connecting portion
4: transparent electrode pattern (second transparent electrode pattern)
5: insulating layer
6: another conductive element
10: capacitive input device
11: transparent film
12: metal oxide particle-containing layer (may have the function of a transparent insulating layer)
13: laminate
14: cover member
15: display device
16: temporary support
18: pressure sensitive adhesive layer
20: transfer film
21: region in which transparent electrode pattern, second curable transparent resin layer, and first curable transparent resin layer are laminated in this order
22: non-patterned region
50: PET base material
52: Kapton tape
54: metal oxide particle-containing layer and pressure sensitive adhesive layer
56: temporary support
58: void a: taper angle
D: boundary void width
LY: first direction
LX: second direction

What is claimed is:

1. A transfer film comprising:
a temporary support;
a pressure sensitive adhesive layer; and
a metal oxide particle-containing layer containing metal oxide particles in this order,
wherein a variation of a content of the metal oxide particles in the metal oxide particle-containing layer is equal to or smaller than 10% in a film thickness direction.

2. The transfer film according to claim 1,
wherein the metal oxide particle-containing layer contains a compound having at least one kind of group selected from the group consisting of a carboxy group and a phosphoric acid group.

3. The transfer film according to claim 2,
wherein the metal oxide particle-containing layer contains at least one kind of compound selected from the group consisting of a compound that has a carboxy group, does not have an ethylenically unsaturated group, and has a molecular weight less than 2,000 and a compound that has a phosphoric acid group and a molecular weight less than 2,000.

4. The transfer film according to claim 3,
wherein a total content of the compound that has a carboxy group, does not have an ethylenically unsaturated group, and has a molecular weight less than 2,000 and the compound that has a phosphoric acid group and a molecular weight less than 2,000 is 0.1% by mass to 20% by mass with respect to a total mass of the metal oxide particle-containing layer.

5. The transfer film according to claim 2, further comprising:
a resin that has at least one of a carboxy group or a phosphoric acid group and has a molecular weight equal to or higher than 2,000 and equal to or lower than 10,000, a glass transition temperature equal to or lower than 23° C., and an acid value equal to or higher than 80 mgKOH/g.

6. The transfer film according to claim 1,
wherein the pressure sensitive adhesive layer has a tan δ equal to or higher than 1.5 at 23° C., an elongation at break equal to or higher than 600% at 23° C., and a viscosity equal to or lower than 1.0×10⁶ Pa·s at 23° C.

7. The transfer film according to claim 1,
wherein a water vapor transmission rate is equal to or lower than 1,100 g/(m²·day) at 60° C.

8. The transfer film according to claim 1,
wherein a thickness of the pressure sensitive adhesive layer is 5 μm to 200 μm.

9. The transfer film according to claim 1,
wherein a thickness of the metal oxide particle-containing layer is 30 nm to 1,000 nm.

10. A method for manufacturing a laminate, comprising:
on a transparent electrode pattern, laminating the metal oxide particle-containing layer and the pressure sensitive adhesive layer in the transfer film according to claim 1 in this order.

11. A laminate comprising:
a transparent electrode pattern;
a metal oxide particle-containing layer that is disposed adjacent to the transparent electrode pattern and contains metal oxide particles; and
a pressure sensitive adhesive layer that is disposed adjacent to the metal oxide particle-containing layer in this order,
wherein a variation of a content of the metal oxide particles in the metal oxide particle-containing layer is equal to or smaller than 10% in a film thickness direction.

12. The laminate according to claim 11,
wherein the metal oxide particle-containing layer contains a compound having at least one kind of group selected from the group consisting of a carboxy group and a phosphoric acid group.

13. The laminate according to claim 12,
wherein the metal oxide particle-containing layer contains at least one kind of compound selected from the group consisting of a compound that has a carboxy group, does not have an ethylenically unsaturated group, and has a molecular weight less than 2,000 and a compound that has a phosphoric acid group and a molecular weight less than 2,000.

14. The laminate according to claim 13,
wherein a total content of the compound that has a carboxy group, does not have an ethylenically unsaturated group, and has a molecular weight less than 2,000 and the compound that has a phosphoric acid group and a molecular weight less than 2,000 is 0.1% by mass to 20% by mass with respect to a total mass of the metal oxide particle-containing layer.

15. The laminate according to claim 11,
wherein the pressure sensitive adhesive layer has a tan δ equal to or higher than 1.5 at 23° C., an elongation at break equal to or higher than 600% at 23° C., and a viscosity equal to or lower than 1.0×10⁶ Pa·s at 23° C.

16. The laminate according to claim 11,
wherein the pressure sensitive adhesive layer and the metal oxide particle-containing layer have, as one layer, a water vapor transmission rate equal to or lower than 1,100 g/(m²·day) at 60° C.

17. The laminate according to claim 11,
wherein a thickness of the pressure sensitive adhesive layer is 5 μm to 200 μm.

18. The laminate according to claim 11,
wherein a thickness of the metal oxide particle-containing layer is 30 nm to 1,000 nm.

19. A capacitive input device comprising:
the laminate according to claim 11.

20. An image display device comprising:
the capacitive input device according to claim 19.
